(19) United States
(12) Patent Application Publication
(10) Pub. No.: US 2026/0099306 A1
(43) Pub. Date: Apr. 9, 2026

(54) ARTIFICIAL INTELLIGENCE (AI)-BASED USER INTERFACES

(71) Applicant: Zoom Video Communications, Inc., San Jose, CA (US)

(72) Inventors: Zheng Chen, Bellevue, WA (US); Pengcheng He, Seattle, WA (US); Xuedong David Huang, Yarrow Point, WA (US); Mark Kawano, San Mateo, CA (US); Bo Yan, Sammamish, WA (US)

(73) Assignee: Zoom Video Communications, Inc., San Jose, CA (US)

(21) Appl. No.: 18/908,537

(22) Filed: Oct. 7, 2024

(51) Int. Cl. G06F 8/38

(52) U.S. Cl. CPC G06F 8/38

(57) ABSTRACT

One example method includes receiving, via a conversational user interface (“CUI”) of an artificial intelligence (“AI”) user interface (“AI-UI”) of an AI assistant, a user input, the AI-UI provided by a client application executed by a client device associated with a user; determining, using an AI model, one or more components of a graphical user interface (“GUI”), based on the user input; dynamically generating, using the AI model, the GUI based on the determined one or more components; and presenting the GUI within the AI-UI.

### FIELD

The present application generally relates to artificial intelligence and user interfaces and more particularly relates to artificial intelligence (AI)-based user interfaces (“UIs”).

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIGS. 1-2 show examples systems for AI-based UIs;

FIGS. 3A-3C show an example system for AI-based UIs

FIGS. 4A-4H show an example AI-based UI;

FIGS. 5-6 show example methods for AI-based UIs; and

FIG. 7 shows an example computing device suitable for use with example systems and methods for AI-based UIs.

### DETAILED DESCRIPTION

Examples are described herein in the context of AI-based UIs. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application-and business-related constraints, and that these specific goals will vary from one implementation to another and from one developer to another.

In conventional computing systems, users interact with the computing system (or “computer”) via a UI, typically a graphical UI (“GUI”), provided by a software application or the underlying operating system (“OS”) executed by the computer. GUIs provide graphical components that collectively provide an intuitive way to present information to the user, identify options or information needed from the user, and allow the user to interact with the various options or input information into the GUI. For example, GUIs may provide options, such as menus, radio buttons, or text fields, graphical or textual information, icons that may be used to invoke functionality offered by the application or by a different application, or other interactive components to enable the user to make use of the software application or OS.

More recently, chat-based interfaces have been used to allow a user to interact with an AI model, such as a chatbot or a large language model (“LLM”), to ask questions or request an action be taken. For example, a user may interact with a relatively simple chatbot provided by a local DMV to renew the license plate for their car, or they may interact with an LLM to request the LLM generate content for the user, such as a document or a summary of inputted text.

However, truly AI-based UIs do not exist. While chatbots and LLMs may expose some AI functionality to a user, these functionalities do not integrate with GUIs the user is interacting with and thus cannot be recruited to assist the user when using such GUIs.

To provide an AI-based UI, a software application presents the user with a user interface that includes two portions, a GUI portion and a conversational UI (“CUI”) portion. The CUI provides integration between the GUI and the CUI to enable information within the GUI to be accessible to the CUI and to allow the CUI to generate, modify, or otherwise interact with the GUI. For example, a user interacting with the AI-based UI (or “AI-UI”), may first interact with the CUI to request help with booking a travel to visit family in Seattle for the holidays by entering a natural language input into the CUI, e.g., by typing it or speaking into a microphone. The CUI receives the input and processes it, such as by providing it to an LLM to extract semantic content from the input and determine actions the user wishes to take.

The CUI, in this case, determines via the LLM that the user wishes to travel Seattle. It determines that additional information is needed, such as the mode of travel, and requests some additional information from the user, such as mode of travel, and after the user responds that they wish to travel by air, the CUI identifies external services that can be used to book travel for the user. The CUI may also request additional information from the user; however, travel information may be more easily entered via a GUI, so the CUI generates a GUI to obtain information needed to identify potential flight options. The CUI generates a prompt to the LLM requesting the kind of information needed to book a flight, to which the LLM identifies (1) origin, (2) destination, (3) departure date, and (4) return date. It may also identify additional information, such as preferred departure or arrival times and preferred airline(s).

Upon receiving the information from the LLM, the CUI asks the LLM to generate several GUI components to obtain that information from the user. In this case, the CUI asks the LLM to generate hypertext markup language (“HTML”) to obtain the information and specifies the types of GUI components to use, such as text fields, radio buttons, or drop-down menus, as well as information to populate in one or more of those GUI components. After receiving the generated HTML, the CUI provides it to the software application to generate and present the GUI to the user in a region adjacent to the CUI.

The user can then interact with the GUI to enter selections, which the application then provides to the CUI. In some examples, the user can select an option to request assistance with one or more components displayed within the GUI, which may be passed to the CUI. After receiving the user input, the CUI may access one or more external services to obtain available flights for the dates, times, and cities identified by the user, and generate a new GUI for the user based on the received information. For example, if the user specifies a particular airline, the CUI may invoke an app associated with that airline, obtain GUI information from that app, update one or more input fields based on previously received information from the user, and present the app's GUI to the user with the user's input pre-entered within the GUI.

In some examples, the CUI may invoke functionality in the app based on the user input before any GUI is ever presented to the user. For example, rather than presenting a flight search GUI from the airline's app to the user, the CUI may instead, invoke the app to perform the search for flights based on the user input and then receive and present the available flights to the user via the software application's GUI. The user may then interact with the GUI to make additional selections. The additional inputs may be provided to the CUI as well as to the airline's app to enable the CUI to assist the user or perform additional functionality. Ultimately, the user may be able to book the flight via the GUI, which information may also be provided to the CUI for further action, such as to add to the user's calendar.

By providing an AI-based UI that integrates a natural language chat interface with a dynamically generated conventional GUI, a software application may significantly improve the user experience when attempting to perform various tasks. Rather than requiring a user to locate the desired functionality, e.g., finding the desired app or website, the user can interact with the CUI, which can then manage the process of identifying the relevant functionality, generating and presenting a GUI to the user to enable intuitive interactions to achieve the desired goals, while assisting the user during the entire process. Thus, an AI-based UI may provide a much more powerful, but intuitive, human-machine interface (“HMI”) to the user.

This illustrative example is given to introduce the reader to the general subject matter discussed herein and the disclosure is not limited to this example. The following sections describe various additional non-limiting examples and examples of AI-based UIs.

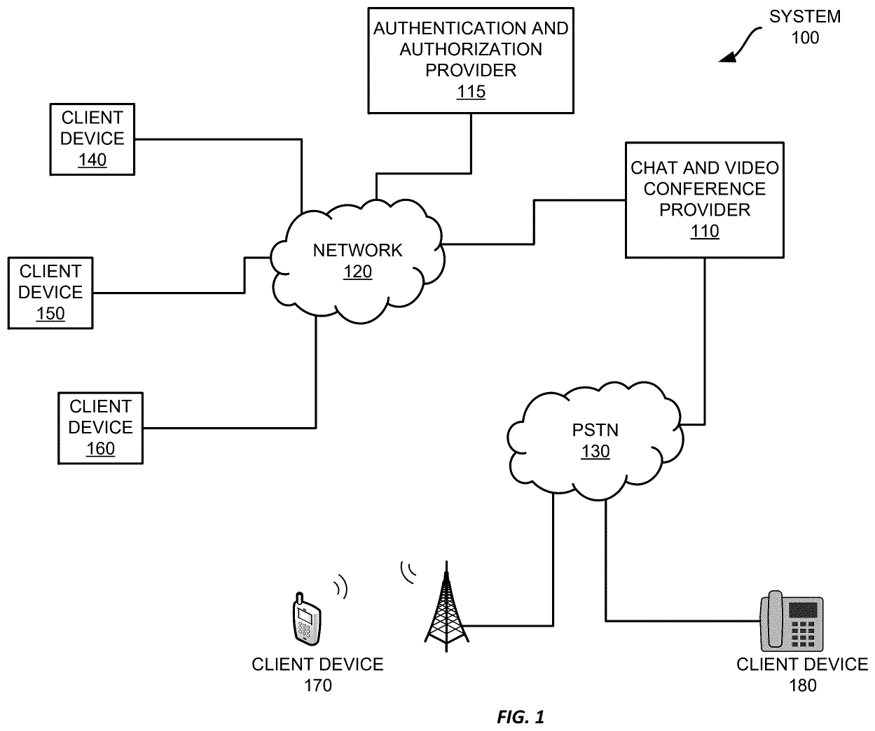

Referring now to FIG. 1, FIG. 1 shows an example system 100 that provides videoconferencing functionality to various client devices. The system 100 includes a chat and video conference provider 110 that is connected to multiple communication networks 120, 130, through which various client devices 140-180 can participate in video conferences hosted by the chat and video conference provider 110. For example, the chat and video conference provider 110 can be located within a private network to provide video conferencing services to devices within the private network, or it can be connected to a public network, e.g., the internet, so it may be accessed by anyone. Some examples may even provide a hybrid model in which a chat and video conference provider 110 may supply components to enable a private organization to host private internal video conferences or to connect its system to the chat and video conference provider 110 over a public network.

The system optionally also includes one or more authentication and authorization providers, e.g., authentication and authorization provider 115, which can provide authentication and authorization services to users of the client devices 140-160. Authentication and authorization provider 115 may authenticate users to the chat and video conference provider 110 and manage user authorization for the various services provided by chat and video conference provider 110. In this example, the authentication and authorization provider 115 is operated by a different entity than the chat and video conference provider 110, though in some examples, they may be the same entity.

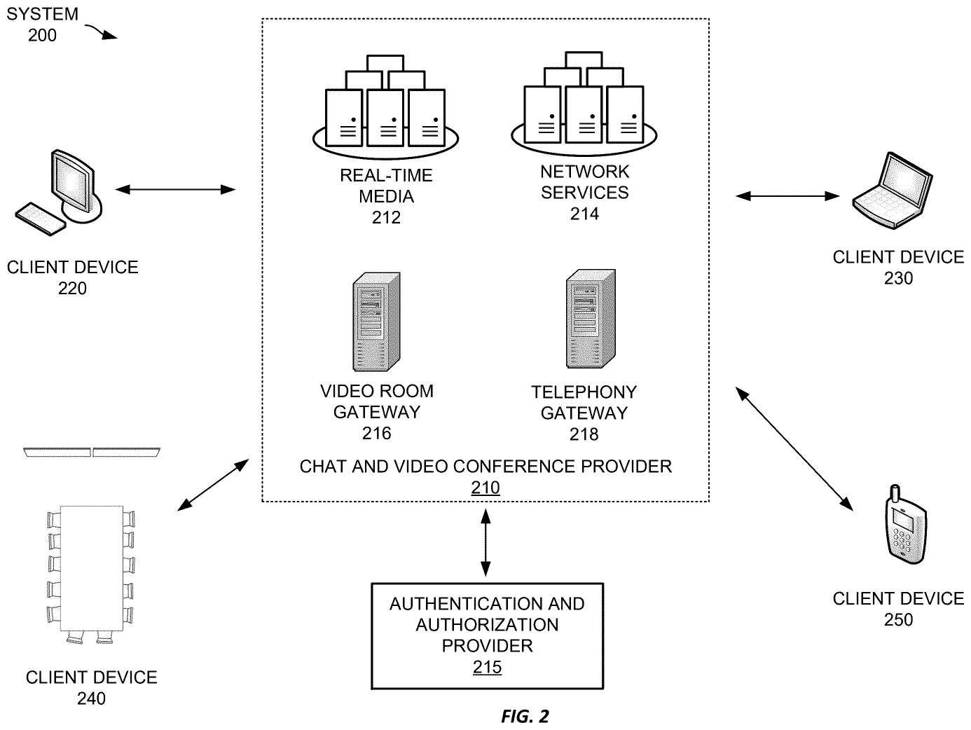

Chat and video conference provider 110 allows clients to create videoconference meetings (or “meetings”) and invite others to participate in those meetings as well as perform other related functionality, such as recording the meetings, generating transcripts from meeting audio, generating summaries and translations from meeting audio, manage user functionality in the meetings, enable text messaging during the meetings, create and manage breakout rooms from the virtual meeting, etc. FIG. 2, described below, provides a more detailed description of the architecture and functionality of the chat and video conference provider 110. It should be understood that the term “meeting” encompasses the term “webinar” used herein.

Meetings in this example chat and video conference provider 110 are provided in virtual rooms to which participants are connected. The room in this context is a construct provided by a server that provides a common point at which the various video and audio data is received before being multiplexed and provided to the various participants. While a “room” is the label for this concept in this disclosure, any suitable functionality that enables multiple participants to participate in a common videoconference may be used.

To create a meeting with the chat and video conference provider 110, a user may contact the chat and video conference provider 110 using a client device 140-180 and select an option to create a new meeting. Such an option may be provided in a webpage accessed by a client device 140-160 or a client application executed by a client device 140-160. For telephony devices, the user may be presented with an audio menu that they may navigate by pressing numeric buttons on their telephony device. To create the meeting, the chat and video conference provider 110 may prompt the user for certain information, such as a date, time, and duration for the meeting, a number of participants, a type of encryption to use, whether the meeting is confidential or open to the public, etc. After receiving the various meeting settings, the chat and video conference provider may create a record for the meeting and generate a meeting identifier and, in some examples, a corresponding meeting password or passcode (or other authentication information), all of which meeting information is provided to the meeting host.

After receiving the meeting information, the user may distribute the meeting information to one or more users to invite them to the meeting. To begin the meeting at the scheduled time (or immediately, if the meeting was set for an immediate start), the host provides the meeting identifier and, if applicable, corresponding authentication information (e.g., a password or passcode). The video conference system then initiates the meeting and may admit users to the meeting. Depending on the options set for the meeting, the users may be admitted immediately upon providing the appropriate meeting identifier (and authentication information, as appropriate), even if the host has not yet arrived, or the users may be presented with information indicating that the meeting has not yet started, or the host may be required to specifically admit one or more of the users.

During the meeting, the participants may employ their client devices 140-180 to capture audio or video information and stream that information to the chat and video conference provider 110. They also receive audio or video information from the chat and video conference provider 110, which is displayed by the respective client device 140 to enable the various users to participate in the meeting.

At the end of the meeting, the host may select an option to terminate the meeting, or it may terminate automatically at a scheduled end time or after a predetermined duration. When the meeting terminates, the various participants are disconnected from the meeting, and they will no longer receive audio or video streams for the meeting (and will stop transmitting audio or video streams). The chat and video conference provider 110 may also invalidate the meeting information, such as the meeting identifier or password/passcode.

To provide such functionality, one or more client devices 140-180 may communicate with the chat and video conference provider 110 using one or more communication networks, such as network 120 or the public switched telephone network (“PSTN”) 130. The client devices 140-180 may be any suitable computing or communication devices that have audio or video capability. For example, client devices 140-160 may be conventional computing devices, such as desktop or laptop computers having processors and computer-readable media, connected to the chat and video conference provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more users to participate in a video conference meeting hosted by the chat and video conference provider 110.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a user to make conventional telephone calls to other telephony devices using the PSTN, including the chat and video conference provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the user to make and receive phone calls, e.g., using a headset and microphone. Such software may communicate with a PSTN gateway to route the call from a computer network to the PSTN. Thus, telephony devices encompass any devices that can make conventional telephone calls and are not limited solely to dedicated telephony devices like conventional telephones.

Referring again to client devices 140-160, these devices 140-160 contact the chat and video conference provider 110 using network 120 and may provide information to the chat and video conference provider 110 to access functionality provided by the chat and video conference provider 110, such as access to create new meetings or join existing meetings. To do so, the client devices 140-160 may provide user authentication information, meeting identifiers, meeting passwords or passcodes, etc. In examples that employ an authentication and authorization provider 115, a client device, e.g., client devices 140-160, may operate in conjunction with an authentication and authorization provider 115 to provide authentication and authorization information or other user information to the chat and video conference provider 110.

An authentication and authorization provider 115 may be any entity trusted by the chat and video conference provider 110 that can help authenticate a user to the chat and video conference provider 110 and authorize the user to access the services provided by the chat and video conference provider 110. For example, a trusted entity may be a server operated by a business or other organization with whom the user has created an account, including authentication and authorization information, such as an employer or trusted third-party. The user may sign into the authentication and authorization provider 115, such as by providing a username and password, to access their account information at the authentication and authorization provider 115. The account information includes information established and maintained at the authentication and authorization provider 115 that can be used to authenticate and facilitate authorization for a particular user, irrespective of the client device they may be using. An example of account information may be an email account established at the authentication and authorization provider 115 by the user and secured by a password or additional security features, such as single sign-on, hardware tokens, two-factor authentication, etc. However, such account information may be distinct from functionality such as email. For example, a health care provider may establish accounts for its patients. And while the related account information may have associated email accounts, the account information is distinct from those email accounts.

Thus, a user's account information relates to a secure, verified set of information that can be used to authenticate and provide authorization services for a particular user and should be accessible only by that user. By properly authenticating, the associated user may then verify themselves to other computing devices or services, such as the chat and video conference provider 110. The authentication and authorization provider 115 may require the explicit consent of the user before allowing the chat and video conference provider 110 to access the user's account information for authentication and authorization purposes.

Once the user is authenticated, the authentication and authorization provider 115 may provide the chat and video conference provider 110 with information about services the user is authorized to access. For instance, the authentication and authorization provider 115 may store information about user roles associated with the user. The user roles may include collections of services provided by the chat and video conference provider 110 that users assigned to those user roles are authorized to use. Alternatively, more or less granular approaches to user authorization may be used.

When the user accesses the chat and video conference provider 110 using a client device, the chat and video conference provider 110 communicates with the authentication and authorization provider 115 using information provided by the user to verify the user's account information. For example, the user may provide a username or cryptographic signature associated with an authentication and authorization provider 115. The authentication and authorization provider 115 then either confirms the information presented by the user or denies the request. Based on this response, the chat and video conference provider 110 either provides or denies access to its services, respectively.

For telephony devices, e.g., client devices 170-180, the user may place a telephone call to the chat and video conference provider 110 to access video conference services. After the call is answered, the user may provide information regarding a video conference meeting, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the chat and video conference provider 110. For example, telephony devices may be unable to provide authentication information to authenticate the telephony device or the user to the chat and video conference provider 110. Thus, the chat and video conference provider 110 may provide more limited functionality to such telephony devices. For example, the user may be permitted to join a meeting after providing meeting information, e.g., a meeting identifier and passcode, but only as an anonymous participant in the meeting. This may restrict their ability to interact with the meetings in some examples, such as by limiting their ability to speak in the meeting, hear or view certain content shared during the meeting, or access other meeting functionality, such as joining breakout rooms or engaging in text chat with other participants in the meeting.

It should be appreciated that users may choose to participate in meetings anonymously and decline to provide account information to the chat and video conference provider 110, even in cases where the user could authenticate and employs a client device capable of authenticating the user to the chat and video conference provider 110. The chat and video conference provider 110 may determine whether to allow such anonymous users to use services provided by the chat and video conference provider 110. Anonymous users, regardless of the reason for anonymity, may be restricted as discussed above with respect to users employing telephony devices, and in some cases may be prevented from accessing certain meetings or other services, or may be entirely prevented from accessing the chat and video conference provider 110.

Referring again to chat and video conference provider 110, in some examples, it may allow client devices 140-160 to encrypt their respective video and audio streams to help improve privacy in their meetings. Encryption may be provided between the client devices 140-160 and the chat and video conference provider 110 or it may be provided in an end-to-end configuration where multimedia streams (e.g., audio or video streams) transmitted by the client devices 140-160 are not decrypted until they are received by another client device 140-160 participating in the meeting. Encryption may also be provided during only a portion of a communication, for example encryption may be used for otherwise unencrypted communications that cross international borders.

Client-to-server encryption may be used to secure the communications between the client devices 140-160 and the chat and video conference provider 110, while allowing the chat and video conference provider 110 to access the decrypted multimedia streams to perform certain processing, such as recording the meeting for the participants or generating transcripts of the meeting for the participants. End-to-end encryption may be used to keep the meeting entirely private to the participants without any worry about a chat and video conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus, the client devices 140-160 may securely communicate with each other during the meeting. Further, in some examples, certain types of encryption may be limited by the types of devices participating in the meeting. For example, telephony devices may lack the ability to encrypt and decrypt multimedia streams. Thus, while encrypting the multimedia streams may be desirable in many instances, it is not required as it may prevent some users from participating in a meeting.

By using the example system shown in FIG. 1, users can create and participate in meetings using their respective client devices 140-180 via the chat and video conference provider 110. Further, such a system enables users to use a wide variety of different client devices 140-180 from traditional standards-based video conferencing hardware to dedicated video conferencing equipment to laptop or desktop computers to handheld devices to legacy telephony devices. etc.

Referring now to FIG. 2, FIG. 2 shows an example system 200 in which a chat and video conference provider 210 provides videoconferencing functionality to various client devices 220-250. The client devices 220-250 include two conventional computing devices 220-230, dedicated equipment for a video conference room 240, and a telephony device 250. Each client device 220-250 communicates with the chat and video conference provider 210 over a communications network, such as the internet for client devices 220-240 or the PSTN for client device 250, generally as described above with respect to FIG. 1. The chat and video conference provider 210 is also in communication with one or more authentication and authorization providers 215, which can authenticate various users to the chat and video conference provider 210 generally as described above with respect to FIG. 1.

In this example, the chat and video conference provider 210 employs multiple different servers (or groups of servers) to provide different examples of video conference functionality, thereby enabling the various client devices to create and participate in video conference meetings. The chat and video conference provider 210 uses one or more real-time media servers 212, one or more network services servers 214, one or more video room gateways 216, one or more message and presence gateways 217, and one or more telephony gateways 218. Each of these servers 212-218 is connected to one or more communications networks to enable them to collectively provide access to and participation in one or more video conference meetings to the client devices 220-250.

The real-time media servers 212 provide multiplexed multimedia streams to meeting participants, such as the client devices 220-250 shown in FIG. 2. While video and audio streams typically originate at the respective client devices, they are transmitted from the client devices 220-250 to the chat and video conference provider 210 via one or more networks where they are received by the real-time media servers 212. The real-time media servers 212 determine which protocol is optimal based on, for example, proxy settings and the presence of firewalls, etc. For example, the client device might select among UDP, TCP, TLS, or HTTPS for audio and video and UDP for content screen sharing.

The real-time media servers 212 then multiplex the various video and audio streams based on the target client device and communicate multiplexed streams to each client device. For example, the real-time media servers 212 receive audio and video streams from client devices 220-240 and only an audio stream from client device 250. The real-time media servers 212 then multiplex the streams received from devices 230-250 and provide the multiplexed stream to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O as well as network parameters such as packet loss, latency and jitter to determine how to modify the way in which streams are provided.

The client device 220 receives the stream, performs any decryption, decoding, and demultiplexing on the received streams, and then outputs the audio and video using the client device's video and audio devices. In this example, the real-time media servers do not multiplex client device 220's own video and audio feeds when transmitting streams to it. Instead, each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia stream in some examples. As discussed above, multimedia streams may be encrypted between the client devices 220-250 and the chat and video conference provider 210. In some such examples, the real-time media servers 212 may decrypt incoming multimedia streams, multiplex the multimedia streams appropriately for the various clients, and encrypt the multiplexed streams for transmission.

As mentioned above with respect to FIG. 1, the chat and video conference provider 210 may provide certain functionality with respect to unencrypted multimedia streams at a user's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams. In some examples, the chat and video conference provider 210 may allow a meeting participant to notify it of inappropriate behavior or content in a meeting. Such a notification may trigger the real-time media servers to 212 record a portion of the meeting for review by the chat and video conference provider 210. Still other functionality may be implemented to take actions based on the decrypted multimedia streams at the chat and video conference provider, such as monitoring video or audio quality, adjusting or changing media encoding mechanisms, etc.

It should be appreciated that multiple real-time media servers 212 may be involved in communicating data for a single meeting and multimedia streams may be routed through multiple different real-time media servers 212. In addition, the various real-time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the chat and video conference provider 210 via local servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the video conference system and across many different real-time media servers 212.

Turning to the network services servers 214, these servers 214 provide administrative functionality to enable client devices to create or participate in meetings, send meeting invitations, create or manage user accounts or subscriptions, and other related functionality. Further, these servers may be configured to perform different functionalities or to operate at different levels of a hierarchy, e.g., for specific regions or localities, to manage portions of the chat and video conference provider under a supervisory set of servers. When a client device 220-250 accesses the chat and video conference provider 210, it will typically communicate with one or more network services servers 214 to access their account or to participate in a meeting.

When a client device 220-250 first contacts the chat and video conference provider 210 in this example, it is routed to a network services server 214. The client device may then provide access credentials for a user, e.g., a username and password or single sign-on credentials, to gain authenticated access to the chat and video conference provider 210. This process may involve the network services servers 214 contacting an authentication and authorization provider 215 to verify the provided credentials. Once the user's credentials have been accepted, and the user has consented, the network services servers 214 may perform administrative functionality, like updating user account information, if the user has account information stored with the chat and video conference provider 210, or scheduling a new meeting, by interacting with the network services servers 214. Authentication and authorization provider 215 may be used to determine which administrative functionality a given user may access according to assigned roles, permissions, groups, etc.

In some examples, users may access the chat and video conference provider 210 anonymously. When communicating anonymously, a client device 220-250 may communicate with one or more network services servers 214 but only provide information to create or join a meeting, depending on what features the chat and video conference provider allows for anonymous users. For example, an anonymous user may access the chat and video conference provider using client device 220 and provide a meeting ID and passcode. The network services server 214 may use the meeting ID to identify an upcoming or on-going meeting and verify the passcode is correct for the meeting ID. After doing so, the network services server(s) 214 may then communicate information to the client device 220 to enable the client device 220 to join the meeting and communicate with appropriate real-time media servers 212.

In cases where a user wishes to schedule a meeting, the user (anonymous or authenticated) may select an option to schedule a new meeting and may then select various meeting options, such as the date and time for the meeting, the duration for the meeting, a type of encryption to be used, one or more users to invite, privacy controls (e.g., not allowing anonymous users, preventing screen sharing, manually authorize admission to the meeting, etc.), meeting recording options, etc. The network services servers 214 may then create and store a meeting record for the scheduled meeting. When the scheduled meeting time arrives (or within a threshold period of time in advance), the network services server(s) 214 may accept requests to join the meeting from various users.

To handle requests to join a meeting, the network services server(s) 214 may receive meeting information, such as a meeting ID and passcode, from one or more client devices 220-250. The network services server(s) 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services server(s) 214 activates the meeting and connects the host to a real-time media server 212 to enable the host to begin sending and receiving multimedia streams.

Once the host has started the meeting, subsequent users requesting access will be admitted to the meeting if the meeting record is located and the passcode matches the passcode supplied by the requesting client device 220-250. In some examples additional access controls may be used as well. But if the network services server(s) 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services server(s) 214.

After joining a meeting, client devices will send and receive multimedia streams via the real-time media servers 212, but they may also communicate with the network services servers 214 as needed during meetings. For example, if the meeting host leaves the meeting, the network services server(s) 214 may appoint another user as the new meeting host and assign host administrative privileges to that user. Hosts may have administrative privileges to allow them to manage their meetings, such as by enabling or disabling screen sharing, muting or removing users from the meeting, assigning or moving users to the mainstage or a breakout room if present, recording meetings, etc. Such functionality may be managed by the network services server(s) 214.

For example, if a host wishes to remove a user from a meeting, they may select a user to remove and issue a command through a user interface on their client device. The command may be sent to a network services server 214, which may then disconnect the selected user from the corresponding real-time media server 212. If the host wishes to remove one or more participants from a meeting, such a command may also be handled by a network services server 214, which may terminate the authorization of the one or more participants for joining the meeting.

In addition to creating and administering on-going meetings, the network services server(s) 214 may also be responsible for closing and tearing-down meetings once they have been completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a user later attempts to access the meeting, the network services server(s) 214 may deny the request.

Depending on the functionality provided by the chat and video conference provider, the network services server(s) 214 may provide additional functionality, such as by providing private meeting capabilities for organizations, special types of meetings (e.g., webinars), etc. Such functionality may be provided according to various examples of video conferencing providers according to this description.

Referring now to the video room gateway servers 216, these servers 216 provide an interface between dedicated video conferencing hardware, such as may be used in dedicated video conferencing rooms. Such video conferencing hardware may include one or more cameras and microphones and a computing device designed to receive video and audio streams from each of the cameras and microphones and connect with the chat and video conference provider 210. For example, the video conferencing hardware may be provided by the chat and video conference provider to one or more of its subscribers, which may provide access credentials to the video conferencing hardware to use to connect to the chat and video conference provider 210.

The video room gateway servers 216 provide specialized authentication and communication with the dedicated video conferencing hardware that may not be available to other client devices 220-230, 250. For example, the video conferencing hardware may register with the chat and video conference provider when it is first installed and the video room gateway may authenticate the video conferencing hardware using such registration as well as information provided to the video room gateway server(s) 216 when dedicated video conferencing hardware connects to it, such as device ID information, subscriber information, hardware capabilities, hardware version information etc. Upon receiving such information and authenticating the dedicated video conferencing hardware, the video room gateway server(s) 216 may interact with the network services servers 214 and real-time media servers 212 to allow the video conferencing hardware to create or join meetings hosted by the chat and video conference provider 210.

Referring now to the telephony gateway servers 218, these servers 218 enable and facilitate telephony devices'participation in meetings hosted by the chat and video conference provider 210. Because telephony devices communicate using the PSTN and not using computer networking protocols, such as TCP/IP, the telephony gateway servers 218 act as an interface that converts between the PSTN, and the networking system used by the chat and video conference provider 210.

For example, if a user uses a telephony device to connect to a meeting, they may dial a phone number corresponding to one of the chat and video conference provider's telephony gateway servers 218. The telephony gateway server 218 will answer the call and generate audio messages requesting information from the user, such as a meeting ID and passcode. The user may enter such information using buttons on the telephony device, e.g., by sending dual-tone multi-frequency (“DTMF”) audio streams to the telephony gateway server 218. The telephony gateway server 218 determines the numbers or letters entered by the user and provides the meeting ID and passcode information to the network services servers 214, along with a request to join or start the meeting, generally as described above. Once the telephony client device 250 has been accepted into a meeting, the telephony gateway server is instead joined to the meeting on the telephony device's behalf.

After joining the meeting, the telephony gateway server 218 receives an audio stream from the telephony device and provides it to the corresponding real-time media server 212 and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the user of the telephony device to participate in the meeting despite not using a computing device or video.

It should be appreciated that the components of the chat and video conference provider 210 discussed above are merely examples of such devices and an example architecture. Some video conference providers may provide more or less functionality than described above and may not separate functionality into different types of servers as discussed above. Instead, any suitable servers and network architectures may be used according to different examples.

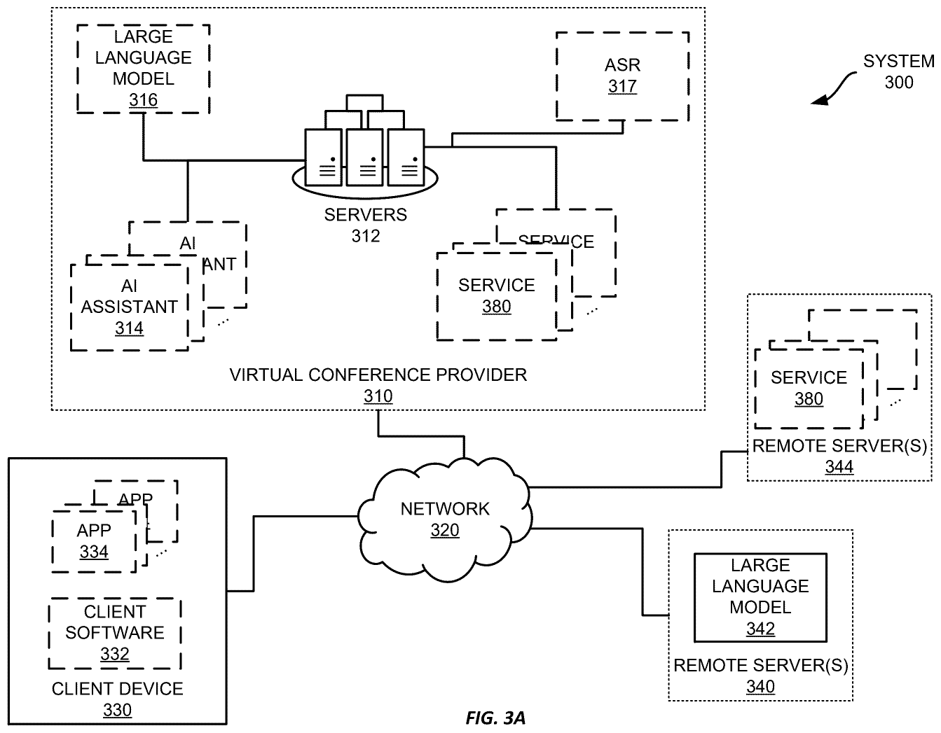

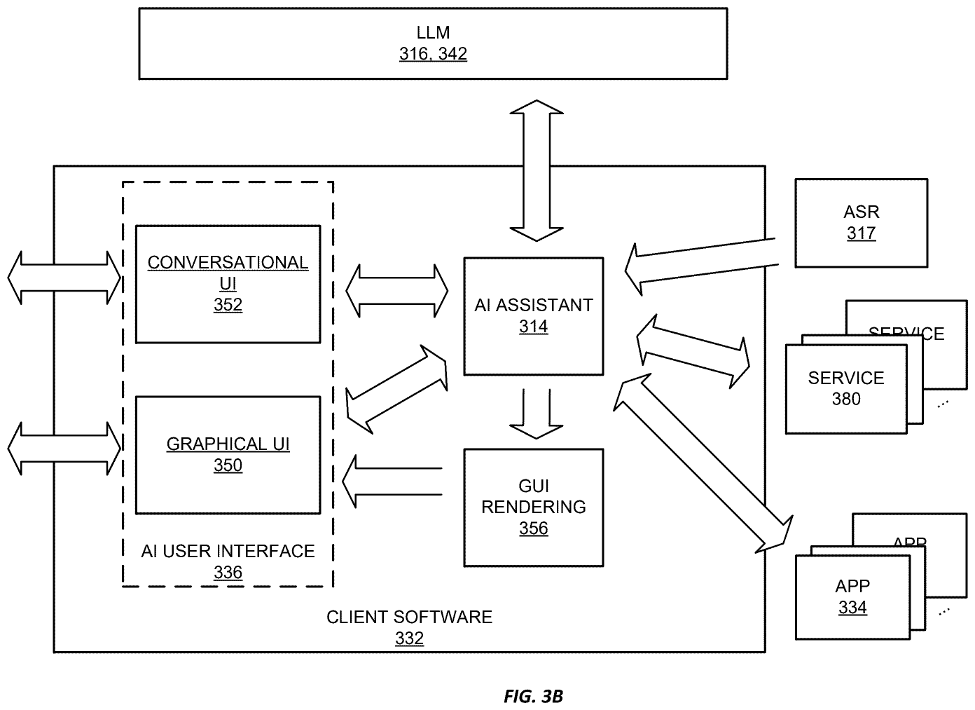

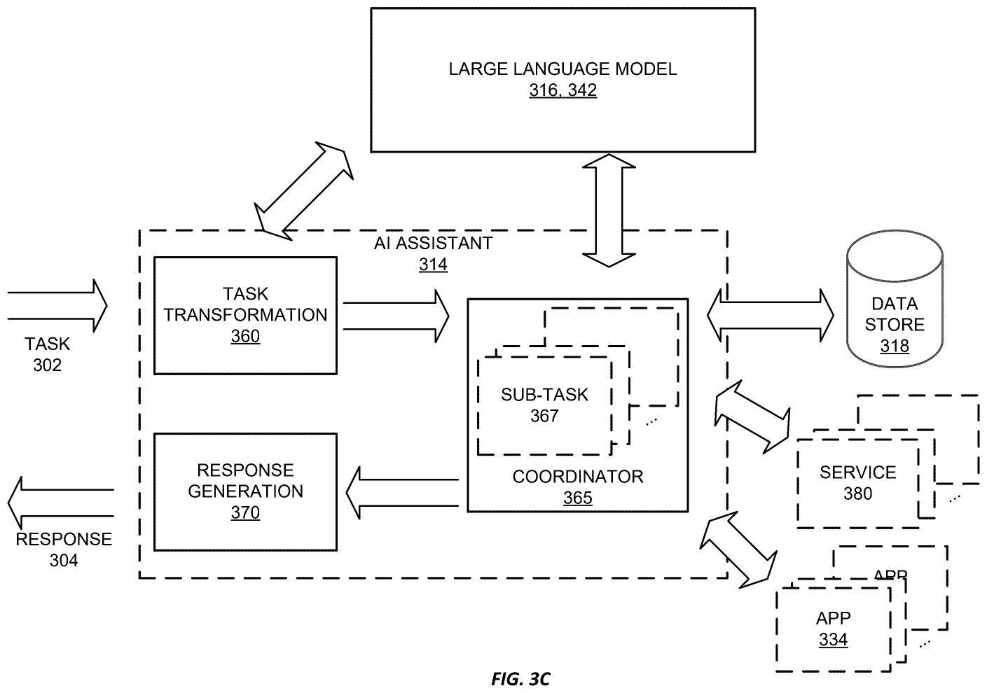

Referring now to FIGS. 3A-3C, FIG. 3A shows an example system 300 for AI-based UIs. In this example, the system 300 includes a client device 330, a virtual conference provider 310, and one or more remote servers 340 that host one or more LLMs 342 and one or more remote servers that host one or more services 380. In this example, the virtual conference provider 310 provides chat and virtual conferencing capabilities, such as discussed above with respect to FIGS. 1-2, but also provides one or more servers 312 that provide one or more LLMs 316 that may be used to service requests received from users via their respective client device, such as client device 330, as well as automatic speech recognition (“ASR”) functionality to enable a user to interact with an AI-based UI using spoken natural language. In addition, the virtual conference provider 310 provides AI assistants 314 to allow users to use AI-based UIs and one or more services 380 usable by the AI-based UIs to provide functionality to the user. And while the AI assistants 314 are shown as hosted by the virtual conference provider 310, it some examples, the client device 330 may include such an AI assistant 314 (as well as an LLM 316, 342, ASR 317, or one or more services 380 or apps 334), either as a stand-alone application or integrated within the client software 332. Similarly, one or more remote servers 340, 344 may host an AI assistant 314 in some examples. In some examples, the client software 332 may provide an interface to employ an AI assistant 314 hosted at the virtual conference provider 310 or one hosted at a third-party server 340, 344. In addition, the remote server(s) 344 may provide one or more services 380 that may be employed by the AI assistant 314 to provide functionality needed to handle a user's interaction with an AI-based UI.

The LLM(s) 316, 342 may be trained on a large corpus of data, such as information available from licensed, commercially usable, non-public datasets. For LLMs, the training data may be written materials, such as webpages, documents, emails, or blogs that may be relevant to generating written works.

Examples of LLMs include GPT models of different versions, autoregressive LLMs (e.g., Large Language Model Meta A (LLaMA)), transformer-based autoregressive LLMs (e.g., BigScience Large Open-science Open-access Multilingual Language Models (BLOOMs)), Zephyr, MISTRAL, causal decoder-only models (e.g., Falcon), or MosaicML Pretrained Transformer (MPT) models.

Client devices 330 may execute client software 332 to join and participate in virtual conferences hosted by the virtual conference provider 310. During a virtual conference, the participants can exchange audio and video streams, as discussed above with respect to FIGS. 1-2, to interact with each other, discuss any topics of interest, and share content. The virtual conference provider 310 may then generate a transcript of the virtual conference, either in real-time or based on a recording of the virtual conference. In addition, the participants can continue any discussions outside of a virtual conference, such as by using chat functionality provided by the virtual conference provider or by collaborating on one or more documents or presentations. They may also email each other using email services provided by the virtual conference provider 310 or another third party. Thus, the participants may generate one or more communication records relevant to various topics of discussion. Moreover, people may communicate about a wide variety of topics over the course of time, whether via written communication like email, chat messages, or text or short message service (“SMS”) messages, or spoken communications, such as via video conferences or telephone calls or conferences.

The client software 332 in this example also provides an AI-UI to allow the user to interact with the client software and AI assistant 314 using either natural language via a CUI or through one or more GUI elements displayed within the AI-UI. These interactions with the AI-UI may enable the user to perform any functionality provided by the client software 332, LLM(s) 316, 342, or services 380 available to the client software 332 by interacting with the AI assistant 314. In this example, the AI-UI is presented to the user on a display of the client device 330 and it interacts with an AI assistant 314, whether hosted at the client device 332, virtual conference provider 310, or remote server 340, 344, that can respond to user inputs via the CUI or the GUI to take requested actions or provide requested information.

To interact with the AI-UI 314, a user of the client device 330 can interact with an interface, such as a chat window in a CUI or with one or more GUI elements presented in the GUI-potion of the AI-UI to provide information or one or more instructions or “prompts” to the AI assistant 314. For example, a user may use the CUI to instruct the AI assistant 314 to “summarize all of my communications from the last two weeks with Steve about Project Alpha.” The AI assistant 314 may then attempt to obtain the relevant communication records and generate a summary for the user. However, to accomplish such a task, the AI assistant 314 may need to identify the actions to be taken to complete the task and on what data to perform the actions. And because the identified actions may involve services provided externally to the AI assistant 314, it may need to determine how to interact with those services, e.g., services 380 hosted by the virtual conference provider 310 or one or more third party servers 344, to obtain whatever result is appropriate. Such services may include database search functionality, email functionality, calendar functionality, LLM prompts, shopping functionality, or any other type of service that can be used via messaging, application programming interface (“API”) calls, or otherwise have external interfaces to enable requests and responses.

To make use of such services to respond to a user's prompt to perform a task, the AI assistant 314 analyzes the incoming prompt to identify services that may be needed to handle the prompt. It can then obtain example commands for those identified services, such as example search commands for an email inbox or a database. The AI assistant 314 can then use the user task, the identified services, and the identified examples for those services to generate one or more instructions for an LLM to create appropriate commands to issue to the various services, as well as the order in which to issue those commands, to handle the task provided by the user. The AI assistant 314 can then access the identified services 380 and provide the LLM-generated commands to those services 380 to obtain suitable results. After processing all of the commands, the final results can be provided to the user, such as via a GUI, a chat message, an email, a document, or any other suitable format.

Similarly, a user may interact with a CUI to request assistance with a particular task, which may generate one or more prompts to the LLM to generate one or more GUI elements to be displayed in the GUI portion of the AI-UI. For example, a user may provide a chat input to the CUI asking for help finding flights for a trip to Colorado to visit a friend or to Hawaii for a vacation. The AI assistant 314 may receive the chat input via the CUI and employ an LLM 316, 342 to identify information to be obtained from the user to help with their request, such as dates and times, destination city, class of service, and so forth. The AI assistant 314 may then generate one or more prompts to the LLM 316, 342 to generate one or more GUI elements to request that information from the user.

For example, the AI assistant 314 may ask the LLM to generate renderable GUI instructions, e.g., HTML, XML, javascript, etc., to generate one or more GUI elements, such as a drop-down menu, one or more radio buttons and corresponding text, a calendar tool, or other element designed to obtain more information about the trip the user wishes to plan. In addition, the LLM may generate a brief description to accompany one or more of the GUI elements, such as the name of the menu or a short heading for one or more radio button options.

To do so, the AI assistant 314 may provide one or more examples of suitable template GUI element instructions along with the request to guide the LLM in generating the renderable GUI instructions. After the AI assistant 314 receives the instructions from the LLM 316, it may then provide them to a GUI rendering engine to render the GUI elements within the GUI. It can then capture user input via the GUI elements to continue searching for suitable flights for the user. Alternatively, if the user specifies a particular airline, the AI assistant 314 may access an installed app 334 for the identified airline and obtain GUI instructions from the app to provide to the GUI rendering engine to render the GUI. The rendered GUI can then capture information to search for suitable flights in essentially the same manner as the custom-generated GUI elements discussed above. It should be appreciated that while services 380 and apps 334 are separately depicted, apps 334 are a type of service 380. Thus, references to the services 380 includes the apps 334 as well.

Referring now to FIG. 3B, FIG. 3B shows the client software 332 executed by the client device 330. The client software 330 in this example includes functionality to provide an AI-UI 336 as well as other functionality, such as to engage in virtual conferences, chat channel discussions, etc. as discussed above with respect to FIGS. 1-2. In this example, the AI-UI 336 includes both a GUI 350 and a CUI 352. The two interfaces 350, 352 collectively provide the AI-UI 336, as well as the underlying functionality provided by the AI assistant 314 and the GUI rendering functionality 356.

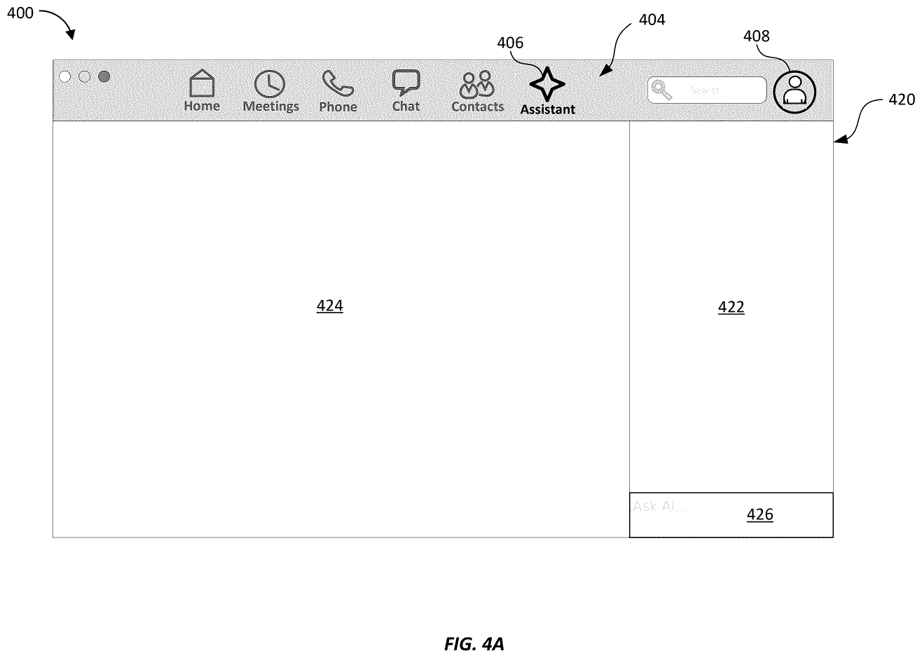

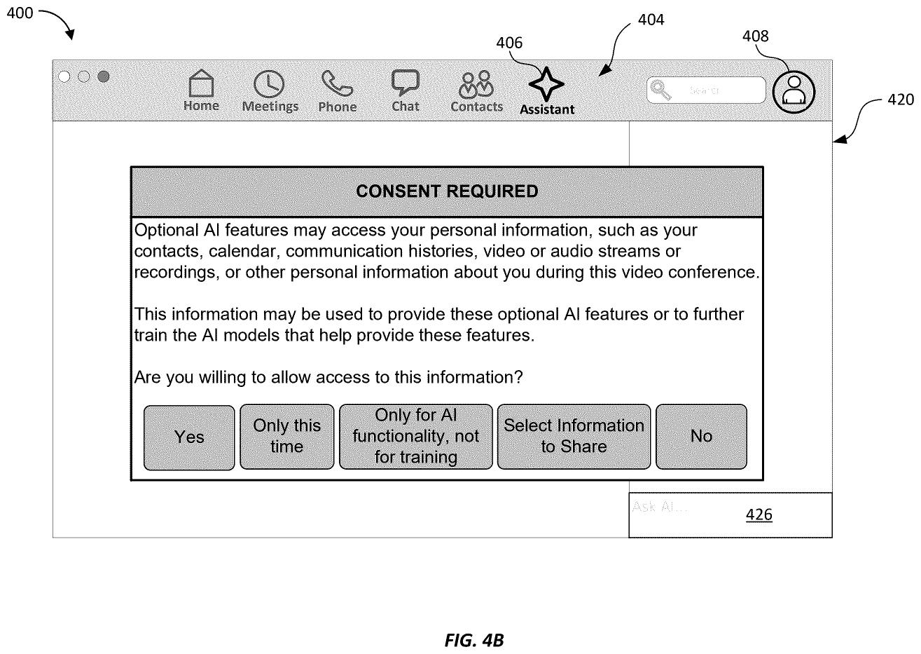

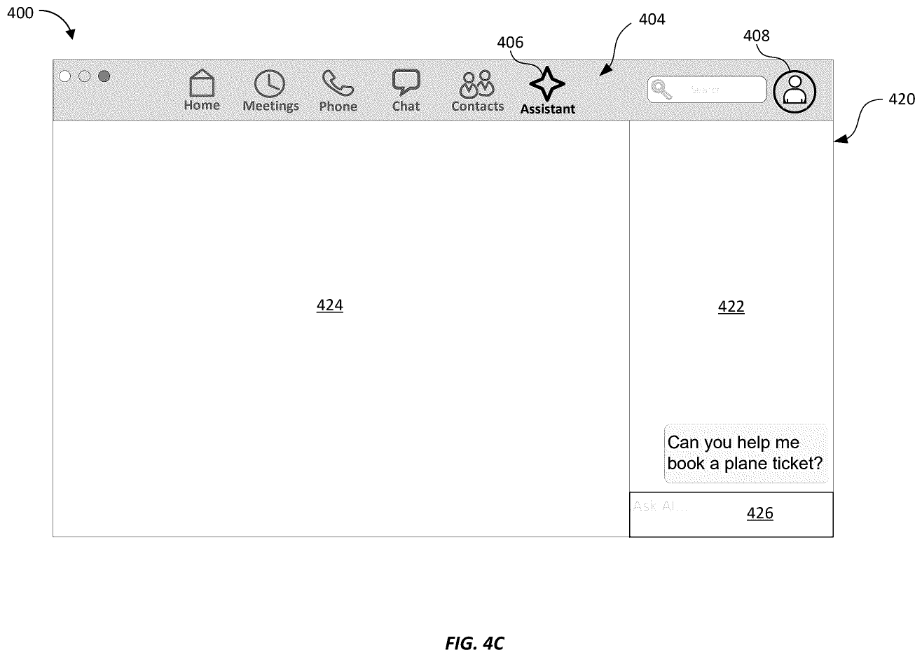

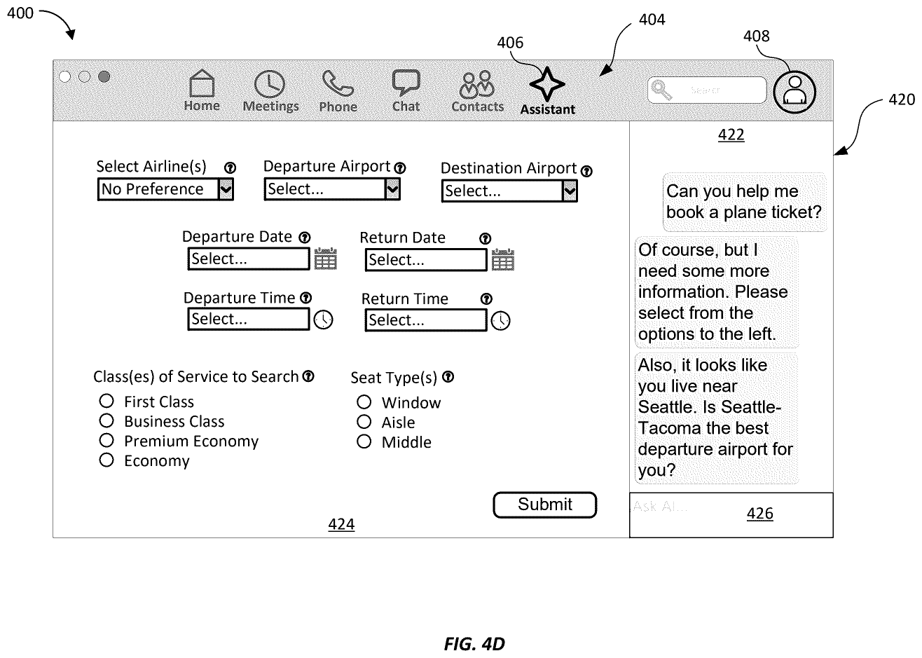

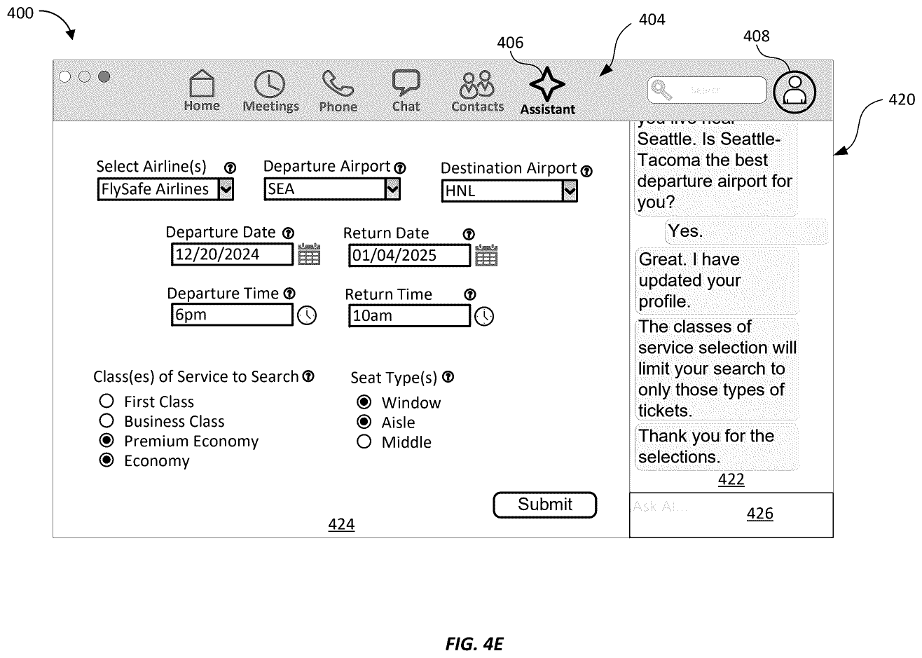

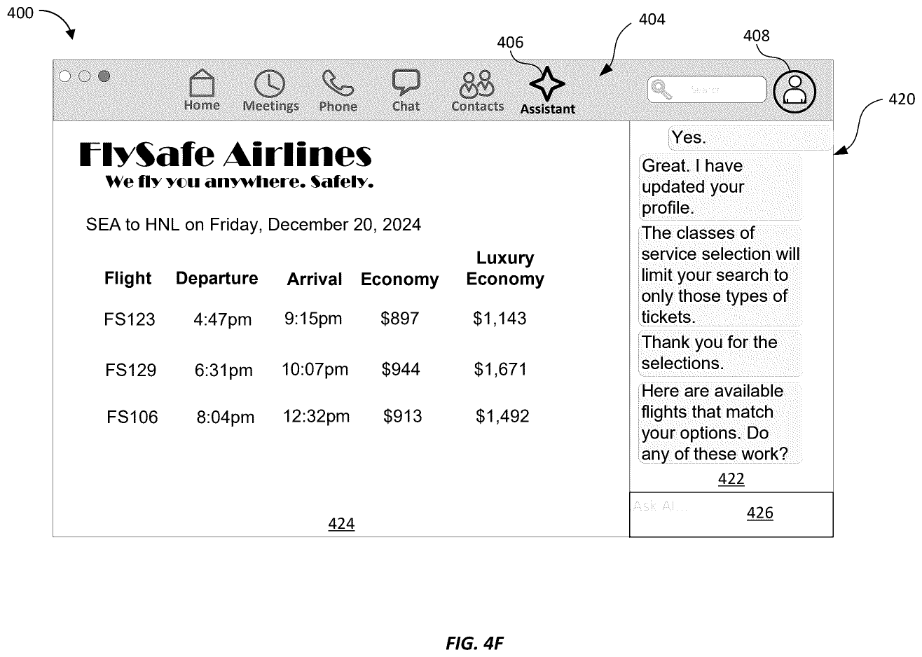

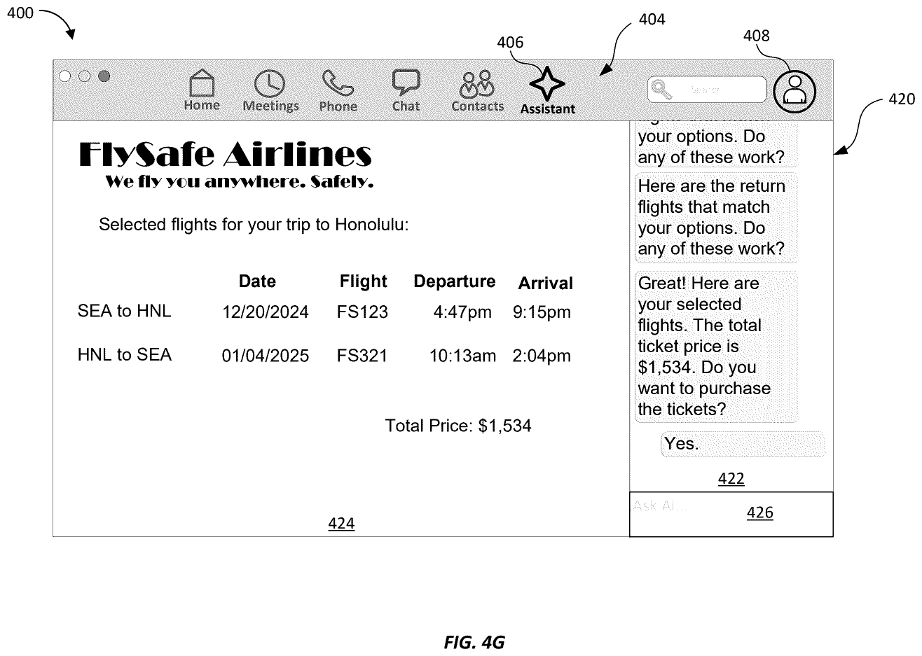

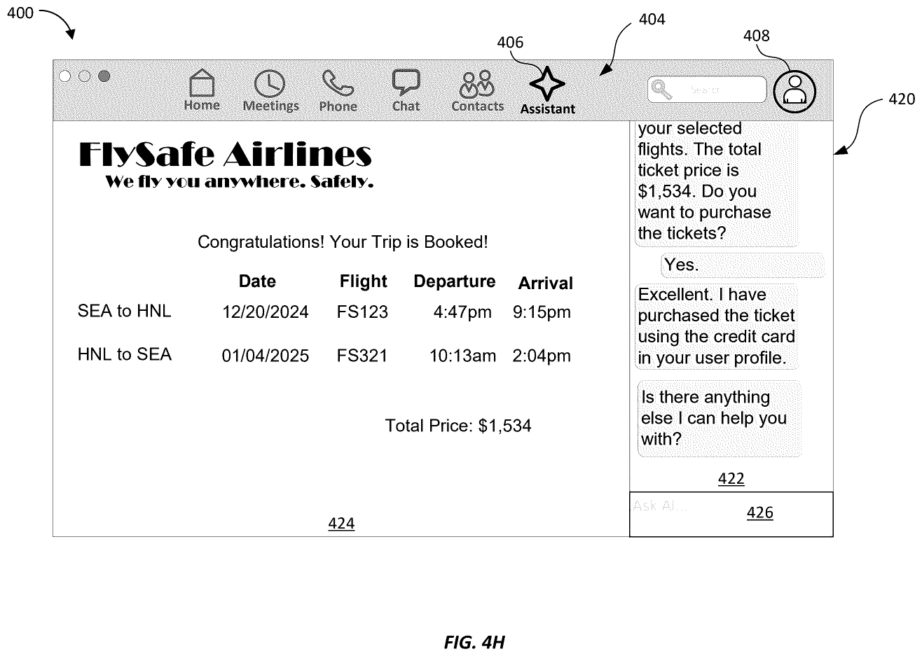

An example arrangement of an AI-UI 336 is shown in FIGS. 4A-4H; however, generally, the AI-UI may be divided into two or more portions for a user, though only one portion may be displayed at any given time. A first portion provides the CUI 350, which enables the user to engage in natural language exchanges with the AI assistant 314 to perform requested actions (e.g., summarize my last meeting) or obtain information (e.g., what is John Smith's email address) without needing to locate the specific functionality or information manually. Thus, the CUI may resemble a chat window with a sequence of user and AI assistant messages that grows over time.

The second portion provides the GUI 350, which may change in appearance depending on the user's interaction with the CUI 352. For example, when the user first accesses the AI-UI, the GUI portion may be blank. Once the user begins to interact with the CUI 352, the AI assistant 314 may generate GUI elements and provide them to the GUI renderer 356 to display within the GUI portion for the user to interact with. Inputs to the GUI elements are then provided to the AI assistant 314.

As user inputs are received by the GUI 350 and CUI 352, they are provided to the AI assistant 314, which employs an LLM 316, 382 to interpret the input and generate responses. The responses may be natural language responses to user input within the CUI 352. In some cases, however, the responses may provide information to enable the AI assistant 314 to employ one or more services 380 to obtain information or perform tasks requested by the user or to obtain GUI information from one or more apps 334 to generate a GUI for the user based on the identified app 334.

Referring now to FIG. 3C, FIG. 3C provides a more detailed view of the AI assistant 314. The AI assistant 314 includes task transformation 360 functionality, a coordinator 365 that can coordinate the execution of one or more sub-tasks 367 and maintain the current status of a task submitted by the user or corresponding sub-tasks 367, and response generation functionality 370 that can generate a response, such as to a user or to the GUI renderer 356, after outputs from the sub-tasks 367 have been generated. As discussed above, the AI assistant 314 can employ one or more services 380 to perform one or more sub-tasks 367. In addition, the AI assistant 314 may access a data store 318 that includes information about the available services 380.

When a task 302 is received from the CUI 352, e.g., from client device 330, the AI virtual assistant 350 employs its task transformation functionality 360 to provide the task 302 to the LLM 316, 342 and request the LLM 316, 342 to break down the task into sub-tasks 367, to provide an ordering for the sub-tasks 367, and to identify additional information to be requested to perform the requested task 302. The task transformation functionality 350 may provide a series of text prompts to the LLM 316, 342 to invoke this functionality such as:
Prompt 1: I have a task that needs to be performed and I have some questions for you about the task. Here is the task: [Task description]
Prompt 2: Please provide the sub-tasks that need to be performed to accomplish this task
Prompt 3: Please identify the ordering of the sub-tasks, including whether any sub-task is not dependent on another sub-task to complete.
Prompt 4: Please identify additional information that should be requested from the user.

In response to the prompts, the LLM 316, 342 provides one or more sub-tasks 367 to be performed, as well as the ordering of those sub-tasks 367, and additional information to be requested from the user.

In some cases, the AI assistant 314 may also request additional information from the user. For example, if a user enters a prompt in the CUI 352 that reads “please help me flight some flights to visit my mom,” the LLM 316, 342 may indicate that additional information, such as dates, times, and departure and destination cities are needed. If additional information is requested, the task transformation functionality 360 may output a message to the user in the CUI 352 identifying the additional information that is needed, such as the services used by the user for Project X, as discussed above.

However, in some examples, the task transformation functionality may instead generate one or more prompts to the LLM 316, 342 to generate one or more GUI elements to display to the user within the GUI 350 to obtain the additional information. To do so the task transformation functionality 360 may generate additional prompts, such as the following:
Prompt 1: Identify the types of information that you need based on the following response. [Response from LLM indicating additional information is needed]
Prompt 2: For each type of information, identify any options for the user to select from, if applicable, and identify the best GUI element to use to obtain the user's selection. The available GUI elements are [Types of GUI elements and descriptions of each].
Prompt 3: Generate the best GUI element for each type of information that has identified options. Here are examples for each type of GUI element that you identified: [Example instructions for each type of GUI element].
Prompt 4: For any type of information that you did not identify any options for, identify the best GUI element to use to obtain the user's selection. The available GUI elements are [Types of GUI elements and descriptions of each].
Prompt 5: Generate the best GUI element for each type of information that does not have identified options and a location on screen for each GUI element. Here are examples for each type of GUI element that you identified: [Example instructions for each type of GUI element].

The responses from the LLM 316, 342 that include instructions to generate one or more GUI elements may then be provided to the GUI renderer 356. The GUI renderer 356 may then render the one or more GUI elements within the GUI 350. For example, instead of asking the user which dates, times, and departure and destination cites should bs used, the AI assistant may issue additional prompts to the LLM to generate a set of drop-down menus, text fields, or calendar or time widgets to obtain the information from the user.

In some examples, GUI elements may be obtained from one or more apps 334 available at the client device 330. For example, apps 334 may provide GUI manifest information to allow for app-specific GUI screens or elements to be generated and displayed by the client software to obtain or provide information. For example, an airline app may provide GUI manifest information to provide a layout for a flight search GUI available via the app. Such information may identify specific GUI elements to be used, the layout of the GUI elements on screen, background graphics to display, and available options for the various GUI elements. In some examples, an app may provide an API or other interface to allow the AI assistant 314 to interface with the app to send instructions (such as queries), obtain information, obtain GUI elements, or other features from the app 334. Thus, the client software may generate GUI elements based on the app's GUI so that it appears that the user is directly interacting with the app, rather than with the client software 332.

After receiving the additional information from the user, the AI assistant 314 submit the task 302 to the LLM 316, 342 with the additional information received from the user via the GUI 350 to allow the LLM 316, 342 to identify one or more sub-tasks 367 to be performed. It should be appreciated that multiple iterations of requests for additional information may occur, each of which may involve generating one or more GUI elements.

After the sub-tasks 367 have been identified, they are provided to the coordinator along with the ordering of the sub-tasks 367. Some sub-tasks 367 may be dependent on the completion of other sub-tasks 367, and thus they must be executed in order. However, some sub-tasks 367 may not be dependent on other sub-tasks 367 and may be executed at any time, or in parallel with other sub-tasks 367. Further, in some cases the LLM 316, 342 indicates that additional information is needed from the user, which the AI assistant 314 may then communicate to the user, such as via one or more generated GUI elements displayed within the GUI 350, as discussed above. After obtaining the additional information, the AI assistant 314 may provide the additional information to the LLM 316, 342 along with information such as the original user task, a sub-task, contextual information such as messages exchanged in the CUI between the user and the AI assistant 314, and so forth. The LLM 316, 342 may then identify one or more additional sub-tasks for the AI assistant 314 to perform.

For example, to assist the user with the flight information requested above, the sub-tasks 367 may include accessing a website for a travel company or airline, or invoking one or more apps 334 provided by various airlines to obtain potential flights matching the user's criteria. And while this scenario involves several requests to obtain information, other tasks may involve more complex sequences of events. Thus, in some cases, the LLM 316, 342 may also specify an order for one or more sub-tasks or it may identify dependencies between sub-tasks. For example, if five sub-tasks are identified, the LLM 316, 342 may specify the order the sub-tasks should be executed in and whether the output of one or more sub-tasks should be used as an input to another sub-task. For example, the LLM 316, 342 may identify five sub-tasks and specify the order as being sub-tasks one and two to be performed first, followed by sub-task three, followed by sub-task four that takes the output of sub-tasks one and three as input, and finally sub-task five that takes the output of sub-tasks two and four as input. The coordinator 365 may obtain the sequencing information in addition to the identified sub-tasks and use the sequencing information to execute the sub-tasks in the proper sequence and with the appropriate inputs.

To execute a sub-task, the coordinator 365 accesses the data store 318 and obtains information about the available apps 334 and services 380. In this example, the data store 318 includes a directory of the available services 380 that includes a textual description of the capabilities of each service 380 as well as instructions regarding how to invoke those capabilities. For services hosted by remote servers 344, the coordinator 365 may request such information from the remote servers 344. The instructions regarding how to invoke service functionality may include a description of an API, one or more functions provided by the API and a description of what each function does and what information it needs and what information it outputs, or a format for a messaging interface or sequence of messages for one or more such functionalities. And while this example involves an API or messaging interface, other interfaces may be used as well, such as inter-process communication or a query interface for a database management system, such as structured query language (“SQL”).

To determine which services to employ, the coordinator 365 may generate an embedding based on the sub-tasks 367 and generate embeddings based on descriptions of the services 380 available to the AI virtual assistant 314 stored in the data store 318. To do so, the coordinator 365 employs a trained ML model, such as a trained autoencoder, a trained predictor model, or any other variety of trained neural network, to generate binary embeddings for the sub-tasks 367 and for descriptions of the available services stored in the data store 318. The binary embeddings may be generated based on the entirety of the sub-tasks 367 or service descriptions, or multiple embeddings may be generated for each based on individual words, phrases, sentences, or other portions of the sub-tasks 367 or service descriptions. The binary embeddings are then used to select one or more relevant services 380. In this example, the coordinator 365 analyzes each service description embedding against the user query embedding to determine a similarity score for the embeddings. If the similarity score satisfies a predetermined threshold, the service is determined to be related to the user query. Otherwise, the service is determined to be not related to the user query. Through this process, relevant services 380 are selected.

In some examples, other techniques may be used to determine relationships between the sub-tasks 367 and one or more services 380. For example, rather than generating binary embeddings using a trained ML model 345, as discussed above, a cross-encoder may be provided with textual inputs representing the sub-tasks 367 and service descriptions. The cross-encoder compares the two textual inputs to determine a similarity between them and outputs a score or confidence indicating the level of similarity, e.g., a value between 0 and 1. Thus, the service selection functionality 350 could employ such a technique to identify services that are sufficiently related to the user query, e.g., the score satisfies a threshold such as 80% or 90%. After analyzing each service description with respect to the sub-tasks 367, a set of related services can be generated. And while these techniques represent some ways to determine relevancy for services, others may be used. For example, the intent classification functionality may employ an LLM to determine the relevance of one or more services 380 to the sub-tasks 367.

For example, after obtaining the information about the available services 380, the coordinator 365 prompts the LLM 316, 342 by identifying a particular sub-task 367 and the descriptions of the available services 380 to determine which service(s) should be invoked to handle the sub-task 367. Based on the sub-task and the descriptions of the available services 380, the LLM 316, 342 identifies one or more services that closely match the sub-task and provides an identification of the service(s) to the coordinator 365. The LLM 316, 342 may also identify an interface, e.g., an application programming interface (“API”) or formatting for messages to be sent to the service, to perform the sub-task. In some examples, the LLM 316, 342 The coordinator 365 can then use the response from the LLM 316, 342 to invoke the appropriate service(s) 380, such as by calling the corresponding API or generating and sending one or more messages to the task, whether hosted by the virtual conference provider 310 or a remote server 344, to obtain information or perform an action. The coordinator 365 can then process each of the sub-tasks 367 in a similar way according to the order defined by the LLM 316, 342. Further, in some examples, the LLM 316, 342 itself may perform the operation specified by the sub-task 367, such as by directly interacting with an appropriate service or services according to the description of the services and instructions regarding how to invoke functionality of those services stored in the data store 318. For example, the LLM 316, 342 may generate and output a message or database command to a service 380 to obtain information from the service 380.

As the sub-tasks 367 are executed and complete, the coordinator 365 accumulates information about each completed sub-task 367, such as information obtained or actions performed. For example, for the user's request for a summary of his conversations about Project X, the various sub-tasks may provide one or more emails, chat logs, or meeting or phone call transcripts to the coordinator. The information may be provided to subsequent sub-tasks 367 to use, such as a summarization sub-task, or may be accumulated to use to generate a response to the user who initially submitted the task 302. If certain sub-tasks depend on the completion of prior sub-tasks, the coordinator 365 can determine whether a further sub-task is ready to be performed based on a completion status of one or more other sub-tasks. For example, in this example, a summary of the conversations needs the underlying conversations to be obtained first. Once any necessary prior sub-tasks have been completed, the coordinator 365 can then execute the further sub-task. Thus, after the coordinator has executed sub-tasks to obtain the various conversation information, such as by invoking services 380 associated with one or more chat channels, an email inbox, and a transcript repository, the coordinator can then invoke the next sub-task and provide the various conversation information as inputs. Thus, the coordinator 365 can employ the sequencing information

Once all of the sub-tasks 367 have completed, the AI assistant 314 invokes its response generation functionality 370 to generate a response to send to the user who submitted the task. In this example, the response generation functionality 370 provides one or more prompts to the LLM 370 to generate a suitable response to the user. In this example, the AI assistant 314 may provide the LLM 316, 342 with the outputs from the sub-tasks, the original task 302, and a prompt asking the LLM 316, 342 whether to provide the information to the user in a GUI 350 or via the CUI 352. For example, the response generation functionality 370 may indicate to the that it should generate GUI elements for any outputs that indicate additional input from the user may be needed, such as a selection of available options. An example of such prompts may be as follows:
Prompt 1: The original task was [task]. And the following output was generated based on that task.
Prompt 2: If the output indicates that additional information is needed from the user or if there are options to select from, identify the types of information that you need based on the following response. [Response from LLM indicating additional information is needed]
Prompt 3: For each type of information, identify any options for the user to select from, if applicable, and identify the best GUI element to use to obtain the user's selection. The available GUI elements are [Types of GUI elements and descriptions of each].
Prompt 4: Generate the best GUI element for each type of information that has identified options. Here are examples for each type of GUI element that you identified: [Example instructions for each type of GUI element].
Prompt 5: For any type of information that you did not identify any options for, identify the best GUI element to use to obtain the user's selection. The available GUI elements are [Types of GUI elements and descriptions of each].
Prompt 6: Generate the best GUI element for each type of information that does not have identified options. Here are examples for each type of GUI element that you identified: [Example instructions for each type of GUI element].
Prompt 7: For any output that does not require a user response, please generate a natural language response to the user based on that output.

The response generation functionality 370 receives any instructions for further GUI elements from the LLM 316, 342 and provides them to the GUI renderer 356 to render in the GUI 350. Such a rendering may replace any existing GUI elements present in the GUI 350, though in some examples, they may be displayed in addition to some or all of any existing GUI elements in the GUI 350. For any other LLM outputs that are not instructions to generate a GUI element, the outputs may be passed to the CUI to display as a textual response to the user.

Such functionality may then iterate as more user input is received via the GUI and passed to the AI assistant 356, such as to complete any additional tasks. For example, if the user initially requested assistance with finding a flight, the AI assistant may first determine that the user needs to provide dates and times and departure and destination cities. The AI assistant 314 may generate GUI elements to obtain that information from the user, which may then be received and passed to the LLM 316, 342 along with the original task as described above. The AI assistant 314 may then invoke a service 380, such as a connection to a travel or airline website to obtain flight information, or to invoke or provide information to a specific airlines'app. Thus, the user may interact with the CUI 352 and the GUI 350 to perform a particular task in an intuitive manner using both natural language and intuitive GUI elements.

In addition, because a task may require multiple iterations of information gathering, after each successive set of prompts sent to the LLM 316, 342 by the AI assistant 314, and outputs generated by the various services 380 for the generated sub-tasks 367, the AI assistant 314 may also submit a prompt to the LLM 316, 342 that provides the original task and the generated output to determine whether the original task has been completed. For example, in the case of purchasing airline tickets, there may be multiple sets of received inputs, selections of flights, changes to inputs, and so forth. Thus, the AI assistant 314 may maintain a particular task as active until the AI assistant 314 prompts the LLM 316, 342 to determine whether the task is complete and receives an affirmative response. Further, because one or more sub-tasks may require additional information, the AI assistant 314 may further track one or more active sub-tasks and, similar to the original task, ask the LLM 316, 342, based on outputs from the one or more sub-tasks 367, whether the sub-task(s) 367 have been completed. Thus, the AI assistant 314 can track the current status of the various tasks and use the LLM 316, 342 to determine when each has been completed.

Referring again to FIG. 3B, as the user interacts with the GUI 350 and the GUI 352 additional tasks may be provided to the AI assistant 314 to handle, as discussed above. For example, as the user navigates GUI elements generated by the AI assistant 314 and rendered by the GUI renderer 356, they may request assistant with one or more GUI elements, such as by selecting a “help” icon, e.g., a ? icon, on the GUI element. Such an input may cause the AI-UI to generate a prompt to the AI assistant requesting an explanation of the GUI element. The AI assistant can then provide information about the GUI element to the LLM 316, 342 in a prompt requesting that the LLM 316, 342 generate an explanation for the user. The explanation may then be provided to the CUI 352 to be displayed as a natural language response. Thus, the AI-UI 336 may be fully interactive and enable cross-communication between the GUI and the CUI based on user inputs in one or the other portions of the AI-UI.

Referring now to FIG. 4A, FIG. 4A shows an example client software GUI 400. The GUI 400 is generated and displayed by client software 332 executed by a client device 330. The GUI 400 provides access to a number of different functionalities provided by the client software 332 or by one or more remote service providers. In this example, the client software 332 is provided by the virtual conference provider 310 to enable a user to access via a set of options 404 various functionality provided by the virtual conference provider 310, such as meetings, phone calls, chat messaging, the user's contacts, and an option 406 to interact with an AI assistant 314. In addition, the user may access their user profile via the user profile option 408 presented in the upper left corner of the GUI 400. In this example, the user has selected the option 406 to interact with the AI assistant, which has caused the client software 332 to generate and provide the AI-UI 420 to the user.

As discussed above with respect to FIGS. 3A-3C, the AI-UI 400 includes both a CUI portion 422 and a GUI portion 424 to allow the user to interact with the AI assistant 314 using whichever input modality the user elects to use. In this case, both portions 422, 424 of the AI-UI 420 are empty because the user has not yet begun interacting with the AI assistant 314. In some examples, the client software 332 may clear the two AI-UI portions 422, 424 after an interaction is completed, though in some examples, the user's interaction history may be preserved each time the user returns to the AI-UI 420. In this example, the CUI portion 422 provides a text entry field 426 to allow the user to type requests to the AI assistant 324; however, it also allows the user to speak a request by employing ASR functionality 317 provided by the virtual conference provider 310. If the user does speak a request, the audio is provided to the ASR functionality 317, which returns a transcription of the user's request, which is automatically entered into the text entry field 426. The user may then edit the request, either verbally or by typing, and may then submit the request to the AI assistant 314.

Referring to FIG. 4B, FIG. 4B shows the GUI 400 presenting a consent option to employ certain AI-assisted features. In some examples according to the present disclosure, a user may select an option to use one or more optional AI features available from the virtual conference provider, such as the AI-based UIs as described herein. The use of these optional AI features may involve providing the user's personal information to the AI models underlying the AI features. The personal information may include the user's contacts, calendar, communication histories, video or audio streams, recordings of the video or audio streams, transcripts of audio or video conferences, or any other personal information available to the virtual conference provider. Further, the audio or video feeds may include the user's speech, which includes the user's speaking patterns, cadence, diction, timbre, and pitch; the user's appearance and likeness, which may include facial movements, eye movements, arm or hand movements, and body movements, all of which may be employed to provide the optional AI features or to train the underlying AI models.

Before capturing and using any such information, whether to provide optional AI features or to providing training data for the underlying AI models, the user may be provided with an option to consent, or deny consent, to access and use some or all of the user's personal information. In general, Zoom's goal is to invest in AI-driven innovation that enhances user experience and productivity while prioritizing trust, safety, and privacy. Without the user's explicit, informed consent, the user's personal information will not be used with any AI functionality or as training data for any AI model. Additionally, these optional AI features are turned off by default—account owners and administrators control whether to enable these AI features for their accounts, and if enabled, individual users may determine whether to provide consent to use their personal information.

In this example, before the user interacts with the AI-UI, the GUI 400 has displayed a consent authorization window for the user to interact with. The consent authorization window informs the user that their request may involve the optional AI feature accessing multiple different types of information, which may be personal to the user. The user can then decide whether to grant permission or not to the optional AI feature generally, or only in a limited capacity. For example, the user may select an option to only allow the AI functionality to use the personal information to provide the AI functionality, but not for training of the underlying AI models. In addition, the user is presented with the option to select which types of information may be shared and for what purpose, such as to provide the AI functionality or to allow use for training underlying AI models.

Referring now to FIG. 4C, the user has elected to begin an interaction with the AI assistant 314 by entering a request in the CUI portion 422. In this case, the user has typed the request into the text entry field of the CUI portion 422 and has asked for assistant with booking a plane ticket.

After the user request is provided to the AI assistant 314, it is processed as discussed above with respect to FIGS. 3A-3C and the AI assistant 314 determines that additional information is needed to help with the user request. In this case, the LLM 316, 342 has identified at least a portion of the additional information needed and has provided several GUI elements to the AI assistant to present to the user in the GUI portion 424 of the AI-UI 420.

Referring now to FIG. 4D, the AI-UI 420 has been updated by the AI assistant 314 based on the additional information identified as being needed by the LLM 316, 342. In this case, the AI assistant 314, via the LLM 316, 342, has determined that various flight options are needed, including departure and return information, which airline(s) the user is interested in using, and information about seats. The LLM 316, 342 has also generated instructions to generate several drop-down menus, form fields (for dates and times), and radio button option groups, as well as inserted calendar and time tool options that the user may select. The AI assistant 314 has also generated heading information for each option and a layout for the GUI portion 424 by requesting that information from the LLM 314, 342. In addition, the AI assistant 314 has accessed the user's user profile and determined their location as being near Seattle. Thus, the AI assistant 314 has suggested a particular airport as the departure airport.

The user may now respond via either the GUI portion 424 or the CUI portion 422, such as by entering text into the text entry field 426 or speaking into a microphone as discussed above. For example, the user could respond “yes” or “no” to the AI assistant's question about the departure airport, which may establish some additional information within the user's profile in addition to selecting the departure airport for the particular flight being searched. For example, the AI assistant may generate a simulated user request to “update my profile to make Seattle-Tacoma airport my default departure airport” and process the request as it would any other request, by providing it to the LLM 316, 342 to generate tasks to perform, as discussed above with respect to FIGS. 3A-3C.

In addition, the GUI portion 424 has added options to request help from the AI assistant for different options presented in the GUI portion 424, depicted by question marks within a circle. The user may select any of the question marks to obtain more information about a particular field from the AI assistant 314, as will be discussed in more detail with respect to FIG. 4E below.

Referring to FIG. 4E, the user has responded to the AI assistant's question in the CUI portion 422 and has also selected a number of options in the GUI portion 424. In addition, the AI assistant 314 has pre-populated the Departure Airport field based on the user's “yes” response to the Seattle-Tacoma airport being the best departure airport. Further, because the airport information was added to the user's profiles, subsequent attempts to find flights may cause the AI assistant 314 to automatically pre-populate the Departure Airport field using that same information. The information provided via the GUI portion 424 has been provided to the AI assistant 314 via the client application 332 by pressing the submit button and the AI assistant 314 has confirmed receipt of the user's selections with a message in the CUI portion 422. And while in this example, the GUI portion 424 includes a “Submit” button, in some examples, as the user inputs information into the GUI portion 424, the inputted information may be provided to the AI assistant 314.

In addition, before submitting their selections, the user has selected the help option corresponding to the “Class(es) of Service to Search” options, which was passed to the AI assistant 314 as a user request constructed from the title of the option and a predefined phrase, such as “Tell me more about [option description].” The request is provided to the AI assistant 314 as a user request, which is handled as discussed above with respect to FIGS. 3A-3C. The AI assistant 314 then responds in the CUI portion 422 to explain the particular option identified by the user for assistance. Thus, the user may learn about GUI elements displayed in the GUI portion 424 in an intuitive way and invoke the AI assistant to help explain the generated GUI.

After receiving the additional information from the user, the AI assistant processes the user request and the additional information generally as described above with respect to FIGS. 3A-3C by breaking the request and additional information down into tasks to complete and then invoking the appropriate services or apps, as described by the LLM 316, 342.

Referring to FIG. 4F, the AI assistant 314 has updated the GUI portion 424 to provide flight options based on the user's selections made in FIG. 4D. However, because the user has selected FlySafe Airlines, the AI assistant 314 has identified a FlySafe application on the user's client device and has obtained a GUI manifest from the application, which provides GUI configuration information for various aspects of the FlySafe application. Such GUI information may include markup language description of different GUIs provided by the FlySafe application, such as XML, SGML, HTML, or other markup languages. In this case, the AI assistant 314 obtains GUI information from the GUI manifest that describes the layout and graphical features for flight selection. In this case, the manifest specifies the layout of information to be provided as well as branding information to be displayed, such as the FlySafe Airlines logo and a marketing slogan.

Based on the GUI information and the information obtained by the AI assistant by processing the user's request, it generates a new display within the GUI portion 424 to provide the look-and-feel of the FlySafe Airline application, with the relevant information inserted within the GUI portion 424 for the user to review. In this example, the GUI portion 424 displays information for several available flights based on the information provided by the user, using the GUI manifest from the FlySafe application. Thus, while the user is actually interacting with the AI assistant 314, it may appear to the user that they are directly interacting with the FlySafe application.

The user may then select an outbound flight and then be presented with a similar GUI having return flights. Once the user has selected suitable flights, they can book the flight through the AI assistant 314. To do so, the AI assistant 314 may interact with the FlySafe application or the FlySafe website. For example, the FlySafe application may provide an application programming interface (“API”) to allow external software to directly interact with the FlySafe application to perform functionality such as booking flights. Similarly, the FlySafe website may provide a similar API or a messaging interface to enable the AI assistant 314 to interact with the website to book a ticket. Information about the API or messaging interfaces may be stored in the data store 318 and used as discussed above to provide examples to the LLM 316, 342 to generate sub-tasks 367 for the AI assistant 314 and instructions for how to invoke the FlySafe application or the FlySafe website to perform the particular task, such as booking a flight or obtaining flight information.

In this example, the user has selected a particular airline that had a corresponding application as discussed above. And while this indirect selection of a particular application was presented to the user as one of several options for flight criteria, in some examples, the user may be presented with the option to explicitly select a particular external application or applications, e.g., for an airline, to use. Such a selection may enable the user to interact with a familiar GUI, as presented via the AI-UI as discussed above.

Referring now to FIG. 4G, the user has selected two flights, outbound and return flights, and has been presented with GUI elements generated by the AI assistant 314 based on the user's selections and after invoking the FlySafe app 334 using those selections. The AI assistant 314 also outputs a message to the CUI portion 314 asking the user to confirm they are ready to book the tickets, to which the user responds with a text message of “Yes.”

Referring to FIG. 4H, the AI assistant 314 has received the user's confirmation to purchase the ticket and again accesses the user's user profile to obtain payment information to book the ticket. The AI assistant 314, after receiving the user's confirmation again invokes the LLM 314, 342 to determine one or more sub-tasks 367 to perform based on the original task, the newly received information, and the most recent prompts from the CUI portion 422. Thus, the LLM 316, 342 is provided the original task of booking a plane ticket, a set of selected flights to book, payment information, and the user's confirmation to purchase the ticket. The LLM 316, 342 may then generate one or more sub-tasks 367 to invoke the FlySafe app to purchase the selected ticket and to generate one or more GUI elements. In this example, the generated GUI element indicates that the trip is booked, but otherwise, does not modify the GUI elements that were previously presented in the GUI portion 424. In addition, a text prompt is generated to indicate that the tickets have been purchased. The AI assistant 314 may also generate a provide a prompt to the LLM 314 asking whether the original task has been completed. The request may include the original task and the current outputted prompts in the CUI (e.g., the prompt indicating the ticket has been purchased) that indicate the status of the task. The LLM 316, 342 may respond that the task is complete. The AI assistant 314 may then output a predefined prompt to ask if the user needs further assistance.

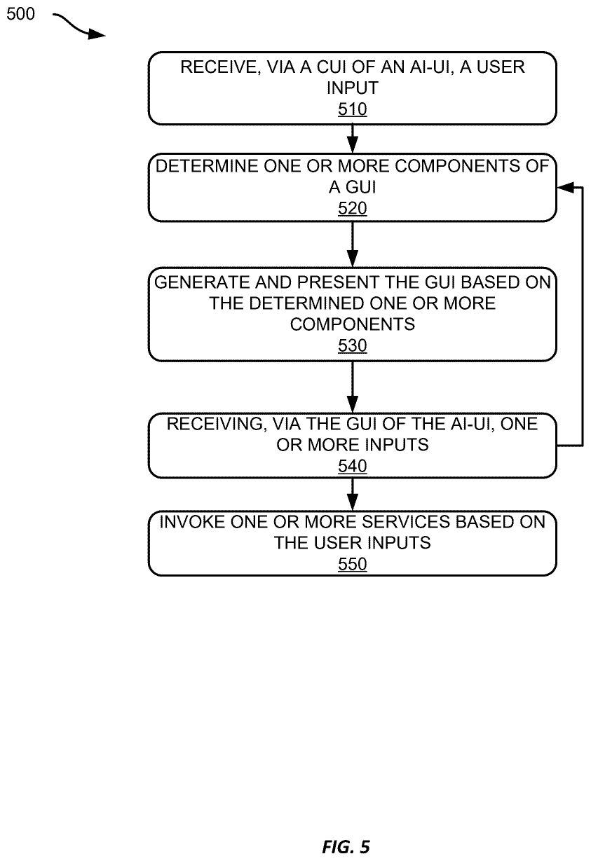

Referring now to FIG. 5, FIG. 5 shows an example method 500 for AI-based UIs. The description of the example method 500 shown in FIG. 5 will be made with respect to the example system shown in FIGS. 3A-3C and the example GUI 400 shown in FIGS. 4A-4H; however, it should be appreciated that any suitable system or GUI may be employed according to this disclosure. Further, while this example is provided with respect to a virtual conference provider, it should be appreciated that any suitable service provider may be used.

At block 510, the client application 332 receives, via a CUI of an AI-UI of an AI assistant 314, a user input. In this example, the user has entered a request into the CUI as shown in FIG. 4C by typing a request into the text entry field 426; however, in some examples, the user may speak a request into a microphone connected to the client device 330. The client software 332 captures the speech from the microphone and transmits it to the virtual conference provider 310, which uses its ASR functionality 317 to transcribe the speech into text and returns it to the client software 332. The client software 332 then inserts the transcribed text into the text entry field 426.

At block 520, the AI-UI 420 determines one or more components of a GUI based on the user input. In this example, the AI-UI 420 provides the user input to the AI assistant 314, which interacts with an LLM 316, 342 as discussed above with respect to FIGS. 3A-3C to generate one or more GUI elements based on the user input. For example, the LLM 316, 342 may generate one or more of a drop-down menu, a radio button, a form field, a calendar tool, a time tool, or other suitable GUI element. The LLM 316, 342 may also generate one or more locations within the GUI portion 424 at which to display one or more of the one or more GUI elements.

At block 530, the AI-UI 420 generates and presents a GUI in the GUI portion 424 based on the determined one or more GUI components. In this example, the client software 332 receives instructions from the AI assistant 314 to generate the GUI elements and uses a GUI renderer to render them within the GUI portion 424 of the AI-UI 420.

At block 540, the AI-UI 420 receives, via the GUI portion 424 of the AI-UI 420, one or more user inputs. The user inputs may correspond to the one or more GUI elements displayed within the GUI portion 424. For example, the user may select one or more options from a drop-down menu, may select dates or times from calendar and time tools, enter date or time information directly into a form field, or select one or more options using the presented radio buttons. Further, as discussed above with respect to FIG. 4D, a user may request additional information about any of the GUI elements by selecting the corresponding help option, depicted by a question mark within a circle. As discussed above, requesting additional information may cause the client application to generate a user prompt to the AI assistant describing the GUI element, e.g., by providing the header for the GUI element, and requesting an explanation of the GUI element, which the AI assistant 314 may processes as a user request to obtain and provide an explanation within the CUI portion 422.

Further in some examples, the AI assistant 314 may prompt the user for information within the CUI portion 422 that may be used to populate options in the GUI portion 424. As discussed above with respect to FIG. 4D, the AI assistant 314 accessed the user's profile and determined that the Seattle-Tacoma airport may be the best departure airport for the user. It then asked the user whether to use that airport. In response to the user confirming that airport is best, the AI assistant 314 then updated the user's user profile and updated the GUI portion 314 to reflect the user's selection via the CUI portion 422. Thus, user inputs to the CUI portion 422 may cause the AI assistant 314 to provided updates for the GUI portion 424.

In some examples, after the user has entered information into the GUI portion 424, the AU-UI 420 return to block 520 to generate and display one or more additional GUI elements to display. While the example in FIG. 4F illustrates one example of such a return to block 520, in some examples, a user may select one option, which may cause the information to be provided to the AI assistant 314 and used to prompt the LLM 316, 342 to generate one or more additional GUI elements that may then be displayed in the GUI portion 424. For example, if the GUI portion 424 displays a GUI element that asks if the user has a TSA precheck number and the user responds that they do, the AI assistant 314 may generate a prompt to the LLM 316, 342 asking if it an additional GUI element should be generated and, if so, to provide instructions to generate the additional GUI element(s). The LLM 316, 342 may then generate instructions for a form field to obtain the user's TSA precheck identification number, which may then be displayed within the GUI portion 424.

At block 550, the AI-UI 420 invokes one or more services based on the user inputs. As discussed above with respect to FIGS. 3A-3C, when the user provides information via the GUI portion 424, it may be used to augment a previously provided user request, such as the request of “Can you help me book a plane ticket” in this example. As discussed above, the additional information may be provided to the AI assistant 314 to be sent to the LLM 316, 342 along with the original request. The LLM 316, 342 may then generate one or more sub-tasks 367 to allow the AI assistant 314 to handle the user's originally request.

For example, as shown in FIG. 4F, after the user supplied information via the GUI portion 424, the AI assistant 422 invoked the FlySafe application to obtain information about flights matching the user's criteria, which then involved generating new GUI elements to display within the GUI portion 424. Thus, as the user continues to interact with the AI-UI 420, additional GUI elements may be generated and displayed. And while the GUI elements in FIG. 4F replaced the GUI elements that had previously been displayed, in some examples, new GUI elements may be displayed in addition to one or more GUI elements that were already present within the GUI portion 424 of the AI-UI 420.

While the example method 500 involved a particular sequence of blocks, it should be appreciated that any suitable sequence may be used. Further, the ordering of the blocks may change according to different examples or one or more blocks may be repeated in some examples.

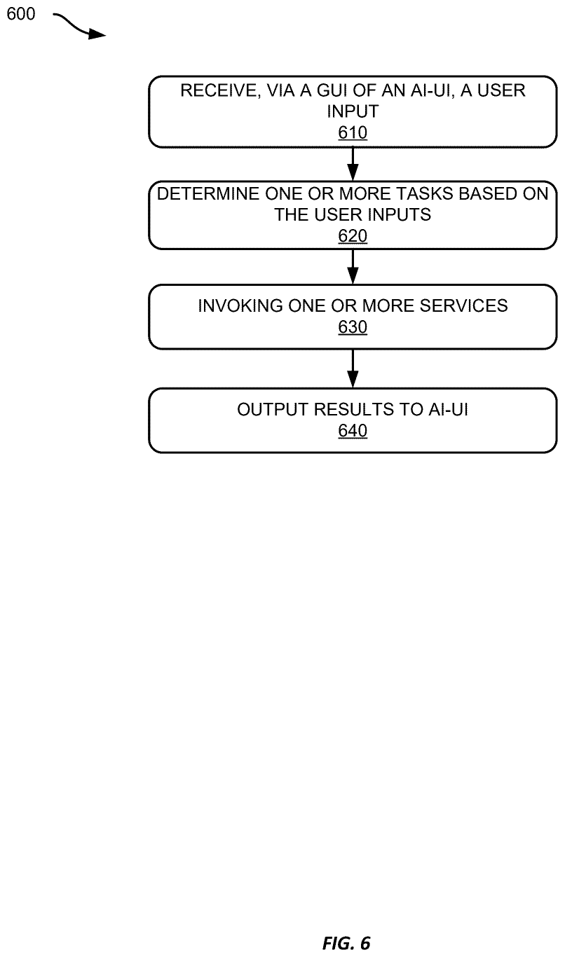

Referring now to FIG. 6, FIG. 6 shows an example method 600 for AI-based UIs. The description of the example method 600 shown in FIG. 6 will be made with respect to the example system shown in FIGS. 3A-3C and the example GUI 400 shown in FIGS. 4A-4H; however, it should be appreciated that any suitable system or GUI may be employed according to this disclosure. Further, while this example is provided with respect to a virtual conference provider, it should be appreciated that any suitable service provider may be used.

At block 610, the client application 332 receives, via a GUI of an AI-UI of an AI assistant 314, a user input. As discussed above, a user may interact with a GUI portion 424 of a AI-UI 420 that has had one or more GUI elements generated by the AI assistant 314. As the user interacts with the GUI elements, they provide information to the AI assistant 314 to assist with a task to be performed, as requested by the user. In this example, the GUI portion 314 provides, in addition to the various GUI elements to obtain flight information, a submit button that the user may select once they have some or inputted all of the requested information. In some examples, the user may submit a portion of the requested information and submit it to the AI assistant 314, which may then provide it to the LLM 314, 342 in conjunction with the original task as discussed above with respect to FIGS. 3A-3C.

And while this example includes a submit button, in some examples, information entered by the user in the GUI portion 424 may be immediately passed to the AI assistant 314 after the user inputs the information. In such an example, the AI assistant 314 may receive the information and ask the LLM 314, 342 whether the AI assistant 314 has received sufficient information to perform the task. If the information is not sufficient, the AI assistant 314 may continue to wait for additional user input. However, if the LLM 314, 342 indicates that sufficient information has been received, the method 600 proceeds to block 620.

At block 620, the AI assistant 314 determines one or more sub-tasks 367 to perform based on a task received from the user and the user input(s) received in the GUI portion 424. To do so, the AI assistant 314 prompts the LLM 314, 342 to process the task and additional information received via the user inputs to generate one or more sub-tasks 367 to execute, as discussed above with respect to FIGS. 3A-3C

At block 630, the AI assistant 314 invokes one or more services 380 to perform the one or more sub-tasks 367, generally as described above with respect to FIGS. 3A-3C. In this example, the AI assistant 314 invokes the FlySafe application, which is one of the apps 334 installed on the client device. Depending on the sub-tasks identified by the LLM 316, 342, the AI assistant 314 may invoked the FlySafe app multiple times in the course of handling the task submitted by the user.

At block 640, the AI assistant 314 outputs a result of the task to the AI-UI 420. In this example, the AI assistant 314 has generated further GUI elements (shown in FIG. 4F) that have replaced the first set of GUI elements (shown in FIGS. 4D-4E). In this example, while the GUI portion 424 has been updated with new GUI elements, the original task (“Can you help me book a plane ticket?”) has not yet been completed. Thus, the AI assistant 314 may continue to receive additional information from the user, such as a selection of a particular flight from the GUI portion 424, and use the LLM 316, 342 to identify additional sub-tasks 367 and identify when the original user task has been completed, as discussed above with respect to FIGS. 3A-3C. Further, as discussed above, user inputs to the GUI portion 424 may cause the AI assistant 314 to generate one or more text prompts that are output to the CUI portion 422 to obtain additional information, such as the confirmation to purchase the plane tickets shown in FIG. 4G. Thus, the user may interact with both portions of the AI-UI 420—the CUI portion 422 and the GUI portion 424—to accomplish a particular task.

While the example method 600 involved a particular sequence of blocks, it should be appreciated that any suitable sequence may be used. Further, the ordering of the blocks may change according to different examples or one or more blocks may be repeated in some examples. Further, while the example method 600 has been described separately from the method 500 shown in FIG. 5, the two methods 500, 600 may be performed concurrently to handle a particular user task while using both the CUI and GUI portions 424, 424 of the AI-UI 420.

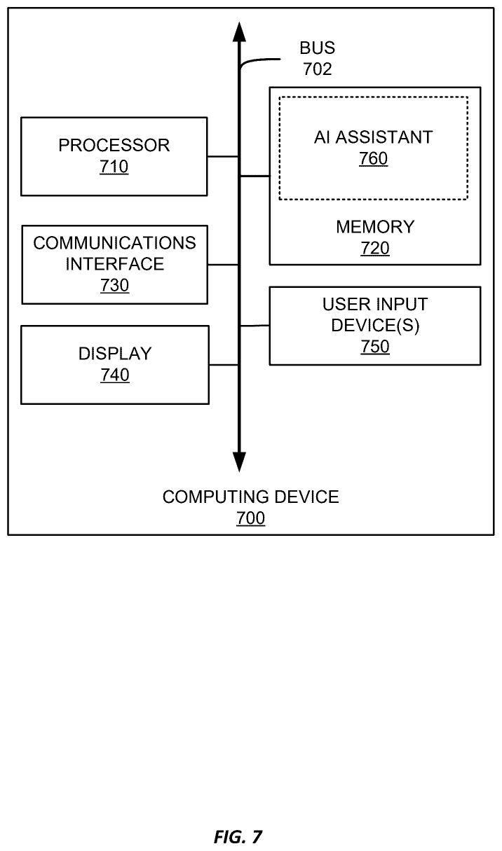

Referring now to FIG. 7, FIG. 7 shows an example computing device 700 suitable for use in example systems or methods for AI-based UIs according to this disclosure. The example computing device 700 includes a processor 710 which is in communication with the memory 720 and other components of the computing device 700 using one or more communications buses 702. The processor 710 is configured to execute processor-executable instructions stored in the memory 720 to perform one or more methods for AI-based UIs according to different examples, such as part or all of the example methods 500, 600 described above with respect to FIGS. 5 and 6. Suitable example computing devices 700, such as user client devices, may also include one or more user input devices 750, such as a keyboard, mouse, touchscreen, microphone, etc., to accept user input. The computing device 700 also includes a display 740 to provide visual output to a user. In addition, the computing device 700 includes an AI assistant 760, such as discussed above with respect to FIGS. 3A-3C.

The computing device 700 also includes a communications interface 730. In some examples, the communications interface 730 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

That which is claimed is:

1. A method comprising:
receiving, via a conversational user interface (“CUI”) of an artificial intelligence (“AI”) user interface (“AI-UI”) of an AI assistant, a user input, the AI-UI provided by a client application executed by a client device associated with a user;
determining, using an AI model, one or more components of a graphical user interface (“GUI”), based on the user input;
dynamically generating, using the AI model, the GUI based on the determined one or more components; and
presenting the GUI within the AI-UI.

2. The method of claim 1, further comprising:
receiving, via the GUI, GUI user inputs comprising data responsive to at least a subset of the one or more components; and
invoking an external service based on the data.

3. The method of claim 1, further comprising:
receiving, via the CUI, a second user input;
determining one or more additional components of the GUI;
dynamically updating the GUI based on the one or more additional components of the GUI; and
presenting the updated GUI within the AI-UI.

4. The method of claim 1, wherein the one or more components comprise one or more data input fields, and further comprising:
determining, using the AI model, one or more data items corresponding to a subset of the one or more data fields;
pre-populating the subset of the one or more data fields based on the one or more data items; and
presenting the GUI and the pre-populated subset of the one or more data fields.

5. The method of claim 4, wherein determining the one or more data items comprising extracting data from the user input using the AI model.

6. The method of claim 4, further comprising accessing, using the AI model, a profile associated with the user, and wherein determining the one or more data items comprises obtaining data from the profile.

7. The method of claim 4, further comprising accessing, using the AI model, a profile associated with the user, and wherein dynamically generating the GUI is based on the profile.

8. The method of claim 1, further comprising:
determining, using the AI model, one or more external client applications based on the user input;
obtaining, from one of the one or more external client applications, a GUI manifest; and
wherein generating the GUI is based on the GUI manifest.

9. The method of claim 8, further comprising:
presenting, within the AI-UI, the one or more external client applications; and
receiving a further user input selecting the one of the one or more external client applications.

10. The method of claim 1, wherein the one or more components of the GUI comprise one or more of a form field, a drop-down menu, or a radio button option.

11. The method of claim 1, further comprising:
receiving, via the CUI, a second user input indicating a first component of the GUI;
generating, using the AI model, a response to the user input, the response comprising information explaining the first component of the GUI; and
presenting the response in the CUI.

12. The method of claim 11, wherein the second user input comprises a request for assistance with the first component of the GUI.

13. A system comprising:
a communications interface;
a non-transitory computer-readable medium; and
one or more processors configured to execute processor-executable instructions stored in the non-transitory computer-readable medium to:
receive, via a conversational user interface (“CUI”) of an artificial intelligence (“AI”) user interface (“AI-UI”) of an AI assistant, a user input, the AI-UI provided by a client application executed by a client device associated with a user;
determine, using an AI model, one or more components of a graphical user interface (“GUI”), based on the user input;
dynamically generate, using the AI model, the GUI based on the determined one or more components; and
present the GUI within the AI-UI.

14. The system of claim 13, wherein the one or more processors are configured to execute further processor-executable instructions stored in the non-transitory computer-readable medium to:
receive, via the GUI, GUI user inputs comprising data responsive to at least a subset of the one or more components; and
invoke an external service based on the data.

15. The system of claim 13, wherein the one or more processors are configured to execute further processor-executable instructions stored in the non-transitory computer-readable medium to:
receive, via the CUI, a second user input;
determine one or more additional components of the GUI;
dynamically update the GUI based on the one or more additional components of the GUI; and
present the updated GUI within the AI-UI.

16. The system of claim 13, wherein the one or more components comprise one or more data input fields, and wherein the one or more processors are configured to execute further processor-executable instructions stored in the non-transitory computer-readable medium to:
determine, using the AI model, one or more data items corresponding to a subset of the one or more data fields;
pre-populate the subset of the one or more data fields based on the one or more data items; and
present the GUI and the pre-populated subset of the one or more data fields.

17. The system of claim 13, wherein the one or more processors are configured to execute further processor-executable instructions stored in the non-transitory computer-readable medium to:
determine, using the AI model, one or more external client applications based on the user input;
obtain, from one of the one or more external client applications, a GUI manifest; and
wherein generating the GUI is based on the GUI manifest.

18. A non-transitory computer-readable medium comprising processor-executable instructions configured to cause one or more processors to:
receive, via a conversational user interface (“CUI”) of an artificial intelligence (“AI”) user interface (“AI-UI”) of an AI assistant, a user input, the AI-UI provided by a client application executed by a client device associated with a user;
determine, using an AI model, one or more components of a graphical user interface (“GUI”), based on the user input;
dynamically generate, using the AI model, the GUI based on the determined one or more components; and
present the GUI within the AI-UI.

19. The non-transitory computer-readable medium of claim 18, further comprising processor-executable instructions configured to cause the one or more processors to:
receive, via the GUI, GUI user inputs comprising data responsive to at least a subset of the one or more components; and
invoke an external service based on the data.

20. The non-transitory computer-readable medium of claim 18, further comprising processor-executable instructions configured to cause the one or more processors to:
receive, via the CUI, a second user input;
determine one or more additional components of the GUI;
dynamically update the GUI based on the one or more additional components of the GUI; and
present the updated GUI within the AI-UI.
